(19) United States
(12) Patent Application Publication
(10) Pub. No.: US 2003/0215667 A1
(43) Pub. Date: Nov. 20, 2003

(54) Electroluminescent devices

(76) Inventor: Shuang Xie, Vancouver (CA)

Correspondence Address: Oyen Wiggs Green & Mutala, #480 - The Station, 601 West Cordova Street, Vancouver, BC, V6B 1G1, CA

(21) Appl. No.: 09/985,204

(22) Filed: Nov. 2, 2001

(51) Int. Cl. H05B 33/14

(52) U.S. Cl. 428/690; 428/917; 313/504; 313/506

(57) ABSTRACT

This invention relates to compositions and electroluminescent (EL) devices that have enhanced performance as a result of a novel class of anthracene derivatives used as host materials for a full range of color dopands. When using coumarin derivatives as color dopands in the anthracene derivatives in an EL device, the device performs a desirable light emitting efficiency and durability. The performance of the EL device can be further improved by using benazole derivatives as the electron transporting layer. The organic EL device of the present invention is useful in preparing display devices.

### FIELD OF THE INVENTION

This invention relates to novel electroluminescent devices with enhanced performance, and which devices are desired that are capable of providing uniform luminescence with full visible spectra, high electroluminescent efficiency, excellent durability, and low driving voltages.

### BACKGROUND OF THE INVENTION

Organic electroluminescent (EL) devices are generally composed of a single or multiple layers of organic materials sandwiched between transparent and metallic electrodes. Organic EL devices are attractive owing to the requirement for low driving voltage and the fact that they are generally simple and relatively easy and inexpensive to fabricate. Furthermore, the light generated by organic EL devices is sufficient for use in a variety of ambient light conditions (from little or no ambient light to bright ambient light). There has been an increased interest in developing energy-efficient flat-panel displays based on organic EL devices primarily because of their potential as an emissive display technology which offers unrestricted viewing angles and high luminescence output at low operating voltages. Because of these advantages, organic EL devices have a potential application in full color flat emissive displays as well as displays in small products, such as pagers, cellular and portable telephones, two-way radios, data banks, and other optical electronic devices.

While recent progress in organic EL research has elevated the potential of organic EL devices for widespread applications, the performance levels of current available devices may still be below expectations. Further, for visual display applications, organic luminescent materials should provide a satisfactory color in the visible spectrum, normally with emission maxima at about 460, 550 and 630 nanometers for blue, green and red. The commonly used metal complexes of 8-hydroxyquinoline, such as tris(8-hydroxyquinolinate)aluminum, generally fluoresce in green or the longer wavelength region. However, for blue-emitting EL devices these electron transport materials are of limited use. Although prior art organic materials may fluoresce in the blue region, the performance characteristics of the resulting EL devices still possess many disadvantages such as poor operation stability. Thus, there continues to be a need for organic materials, which are suitable for the design of EL devices with satisfactory emission in the visible spectrum of from blue to the longer wavelength region. There is also a need for organic materials, which can improve EL device operational stability and durability, and can enhance the EL charge transporting characteristics, thus lowering device driving voltages.

### PRIOR ART

Prior art organic EL devices have been constructed from a laminate of an organic luminescent material and electrodes of opposite polarity, which devices include a single crystal material, such as single crystal anthracene, as the luminescent substance as described, for example, in U.S. Pat. No. 3,530,325. However, these devices require excitation voltages on the order of 100 volts or greater. Subsequent modifications of the device structure through incorporation of additional layers, such as charge injecting and charge transporting layers, have led to performance improvement. Illustrative examples of EL devices have been disclosed in publications by Tang et al. in J. Appl. Phys. vol. 65, pp. 3610 to 3616 (1989) and Saito et al. in Mol. Cryst. Liq. Cryst. Vol. 253, pp. 125 to 132 (1994), the disclosures of which are totally incorporated herein by reference.

An EL device with an organic dual layer structure comprises one layer adjacent to the anode supporting hole injection and transport, and another layer adjacent to the cathode supporting electron injection and transport. The recombination of charge carriers and subsequent emission of light occurs in one of the layers near the interface between the two layers. In another configuration, an EL device can comprise three separate layers, a hole transport layer, an emission layer, and an electron transport layer, which are laminated in sequence and are sandwiched as a whole between an anode and a cathode. Optionally, fluorescent dopant materials can be added to the emission zone or layer whereby the recombination of holes and electrons results in the excitation of the fluorescent dopants. In the three layer organic EL device, the light-emitting layer provides an efficient site for the recombination of the injected hole-electron pair followed by the energy transfer to the guest material and produces the highly efficient electroluminescence.

The emission zone or layer commonly consists of a host material doped with a guest material. The commonly used host materials in light-emitting layer are electron transport materials, such as 8-hydroxyquinoline aluminum complex. U.S. Pat. No. 4,769,292 discloses an EL device employing a luminescent zone comprised of an organic host material capable of sustaining hole-electron recombination and a fluorescent dye material capable of emitting light in response to energy released by hole-electron recombination. The host materials can be hole transporting layer, such as aryl amine (U.S. Pat. No. 5,989,737) or charge injection auxiliary material, such as stilbene derivatives (C. Hosokawa et al., Appl. Phys. Lett., 67(25) 3853, 1995). The doped guest material, also known as the dopant, is usually chosen from highly fluorescent dyes.

### REFERENCES—U.S. PATENT DOCUMENTS

U.S. Pat. No. 5,989,737

U.S. Pat. No. 3,172,862

U.S. Pat. Nos. 4,356,429 and 5,516,577

U.S. Pat. No. 4,539,507

U.S. Pat. Nos. 5,151,629, and 5,150,006

U.S. Pat. No. 5,648,542

U.S. Pat. No. 4,885,211

U.S. Pat. No. 5,429,884

### SUMMARY OF THE INVENTION

It is a feature of the present invention to provide improved organic EL devices with many advantages described herein.

It is another feature of the present invention to provide EL devices capable of providing satisfactory emission in the full range of visible spectrum from blue to longer wavelength regions, high electroluminescent efficiency, excellent durability, and low driving voltages, and high brightness.

Yet in another feature of the present invention there are provided improved EL devices comprising an anode and a cathode, and an organic electroluminescent medium between the anode and the cathode, wherein the organic electroluminescent medium has at least one layer containing anthracene derivatives.

A further feature of the present invention is the provision of EL devices containing anthracene derivatives which possess excellent carrier injecting and transporting capability and superior thermal stability. They can be readily vacuum deposited as thin films for use in EL devices.

Another feature of the present invention is the provision of doped EL devices of whole visible range desirable hue based on the principle of guest-host energy transfer to effect the spectral shift from host to guest.

In embodiments, the present invention relates to EL devices that are comprised of an anode and a cathode, and an organic luminescent medium between the anode and the cathode; the organic electroluminescent medium includes an organic material or a mixture thereof of anthracene derivatives having the structure Formula I.

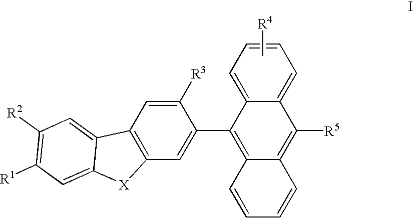

Wherein: R¹, R², R³ and R⁴ are individual hydrogen, alkyl, or alkoxyl groups containing 1 to 16 carbon atoms, alkenyl groups containing at least one carbon-carbon double bond, aryl or substituted aryl group containing 6 to 24 carbon atoms, heteroaryl or substituted heteroaryl group containing 5 to 24 carbon atoms, amino group, N-alkylamino group, N-arylamino group, N,N-dialkylamino group, N,N-diaryl group, cyano group, perfluoroalkyl group containing 1-8 carbon atoms, chlorine, bromine, and fluorine;

R⁵ is alkyl group or perfluoroalkyl group containing 1 to 16 carbon atoms; aryl or substituted aryl group containing 6 to 40 carbon atoms; heteroaryl or substituted heteroaryl group containing 5 to 40 carbon atoms, and cyano group, chlorine, bromine, and fluorine.

X is methylene group, dialkyl methylene and diaryl methylene groups, heteroatom such as oxygen, sulfur, or alkyl or aryl substituted amino groups, or dialkyl or diaryl substituted silyl groups, or carbonyl groups.

In accordance with the present invention, it has also been found that this novel class of anthracene derivatives are extremely useful for the production of full color EL display panel because appropriate EL hues or colors, including white, have been produced by a downhill energy transfer process. For example, a green or red EL emission have been produced by doping into anthracene derivatives with a small amount of green or red luminescent sensitizing dyes called dopants.

One novel class of coumarin derivatives acting as dopands in an EL devices that are comprised of materials of this invention is represented by the following Formula II.

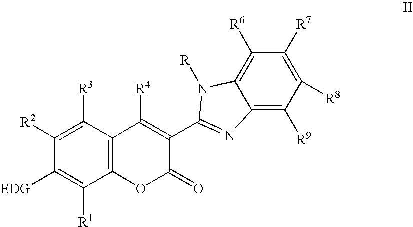

Wherein R is hydrogen, alkyl of from 1-24 carbon atoms, aryl, hereoaryl or carbocyclic systems;

R¹, R², R, R⁴, R⁵, R⁶, R⁷, R⁸ and R⁹ are individually alkyl of from 1 to 20 carbon atoms, aryl or carbocyclic systems;

EDG is hydrogen, alkyl group of from 1-24 carbon atoms, aryl group of from 5-24 carbon atoms, or electron donating groups, more typically are:

—OR¹⁰

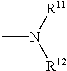

Wherein:R¹⁰, R¹¹ and R¹² are individually alkyl of from 1 to 20 carbon atoms, aryl or carbocyclic systems; R¹¹ and R¹, R¹¹ and R¹², and R¹² and R² taken together can form ring systems, such as piperidine, julolidine, or tetramethyljulolidine.

Another class of anthracene derivatives acting as dopands in an EL devices are comprised of materials of this invention represented by the following Formula III.

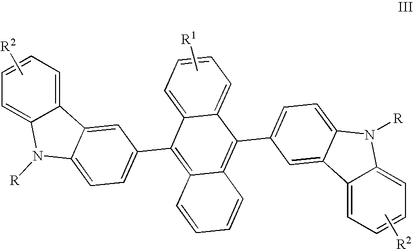

Wherein:

R¹ is alkyl of from 1 to 20 carbon atoms; R and R² are individually hydrogen, alkyl of from 1 to 24 carbon atoms, aryl, hereoaryl group of from 5 to 24 carbon atoms.

In accordance with the present invention, it has also been found that a novel class of benzole derivatives represented by the following Formula IV are typically useful as electron transport materials to form electron transporting layer, and at the same time function as hole block layer.

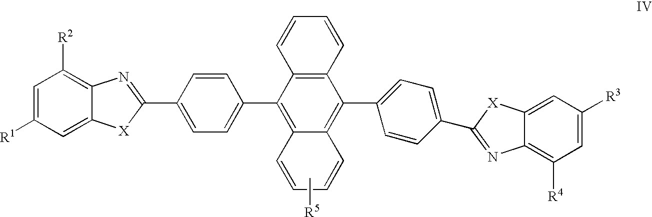

Wherein:

R¹, R², R³, R⁴ and R⁵ are individual hydrogen, alkyl, or alkoxyl groups containing 1 to 16 carbon atoms, aryl or substituted aryl group containing 6 to 24 carbon atoms, heteroaryl or substituted heteroaryl group containing 5 to 24 carbon atoms;

X is methylene group, dialkyl methylene and diaryl methylene groups, S, O or NR, where R is hydrogen, alkyl, or alkoxyl groups containing 1 to 16 carbon atoms, aryl or substituted aryl group containing 6 to 24 carbon atoms.

It is an advantage of the present invention, that the organic electroluminescent (EL) element, which belongs to anthracene, coumarine and benazole derivatives, or their combinations, provides thermally stable, glassy, and highly fluorescent materials in condensed thin films. As a result, organic EL devices employing certain of these derivatives in the light-emitting layer can produce full range of emission spectra and long operational stability.

### DRAWINGS

In drawings, which illustrate specific embodiments of the invention, but which, should not be construed as restricting the spirit or scope of the invention in any way:

FIG. 1 illustrates a five component electroluminescent device.

FIG. 2 illustrates a seven component electroluminescent device.

FIG. 3 illustrates a six component electroluminescent device.

FIG. 4 illustrates a EL spectra of Example 10 and 11.

FIG. 5 illustrates a PL spectra of compounds III-20, Ib-2 and Ib-4 in dichloromethane.

### DESCRIPTION OF EMBODIMENTS

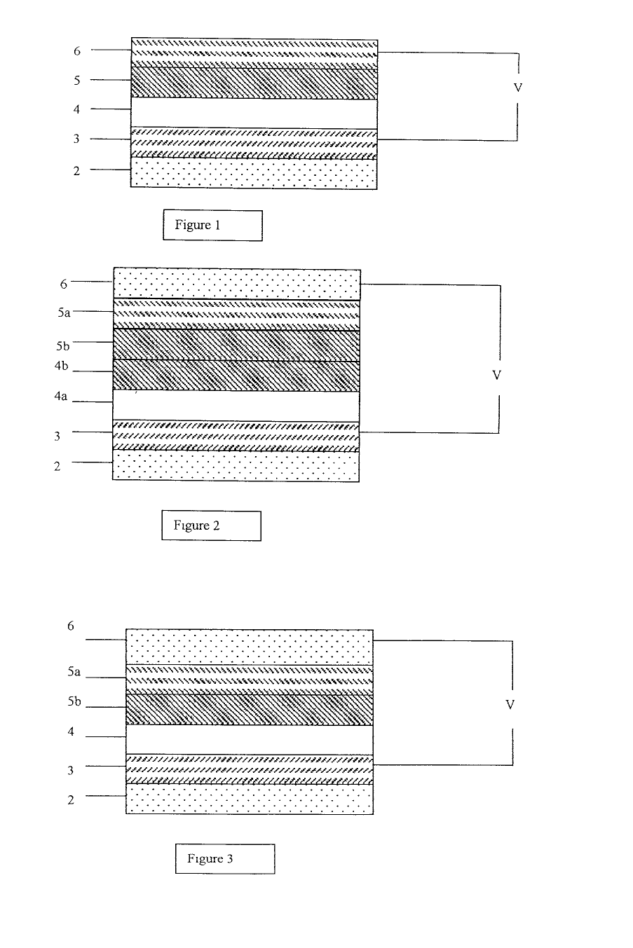

Embodiments of the present invention will be described in more details with reference to the schematic diagram as provided in FIG. 1 and FIG. 2. More specifically, FIG. 1 illustrates an EL device which comprises an organic light emitting diode comprised of a supporting substrate 2 of, for example, glass, an anode 3, a vacuum deposited hole injecting and hole transporting layer 4 comprised of an aromatic amines, an electron injecting and electron transporting layer 5, and in contact therewith a low work function metal as a cathode 6. In the EL device a luminescent zone or medium, in which the electron-hole recombination takes place with subsequent light emission, encompasses the hole transport layer 4 and/or the electron transport layer 5. Optionally, a fluorescent material, which is capable of emitting light subsequent to electron-hole recombination, may be added to the luminescent zone wherein the charge transport component functions as the host material.

In another embodiment as illustrated in FIG. 2, the light emitting diode is comprised of a supporting substrate 2 of, for example, glass, an anode 3, an aromatic amines of the formulas illustrated herein, organic hole transporting zone 4, an organic electron transporting zone 5, and in contact therewith a cathode 6. In this device structure, the transporting zone is comprised of one or more transport layers as opposed to the single layer transporting zone of the device structure of FIG. 1. Specifically, the hole transporting zone 4 of FIG. 2 is comprised of a layer 4a, which facilitates hole injection, and a mixture of isomeric aromatic amines layer 4b, which transports hole carriers. The electron transporting zone 5 is comprised of a layer 5a, which facilitates electron injection, and a layer 5b, which transports electrons.

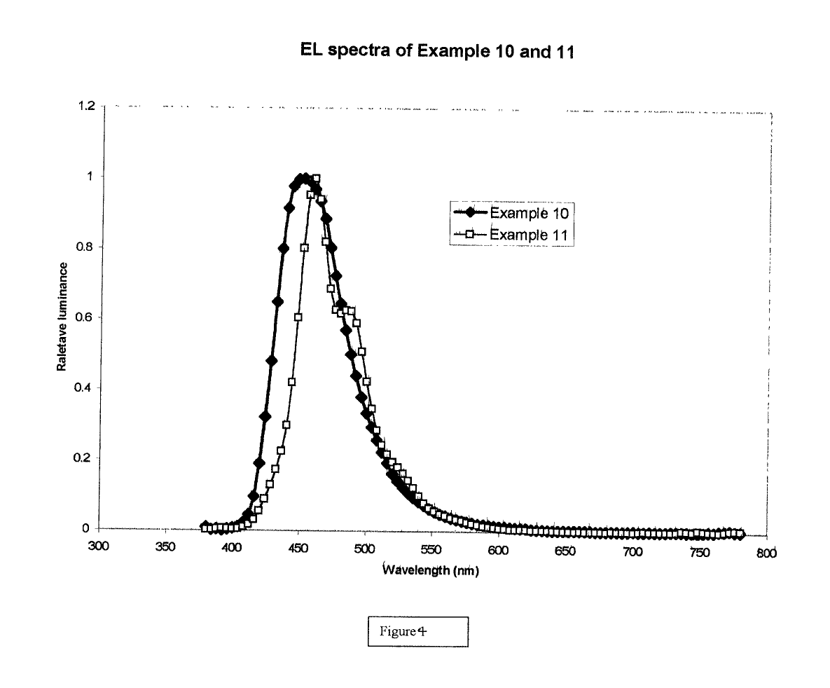

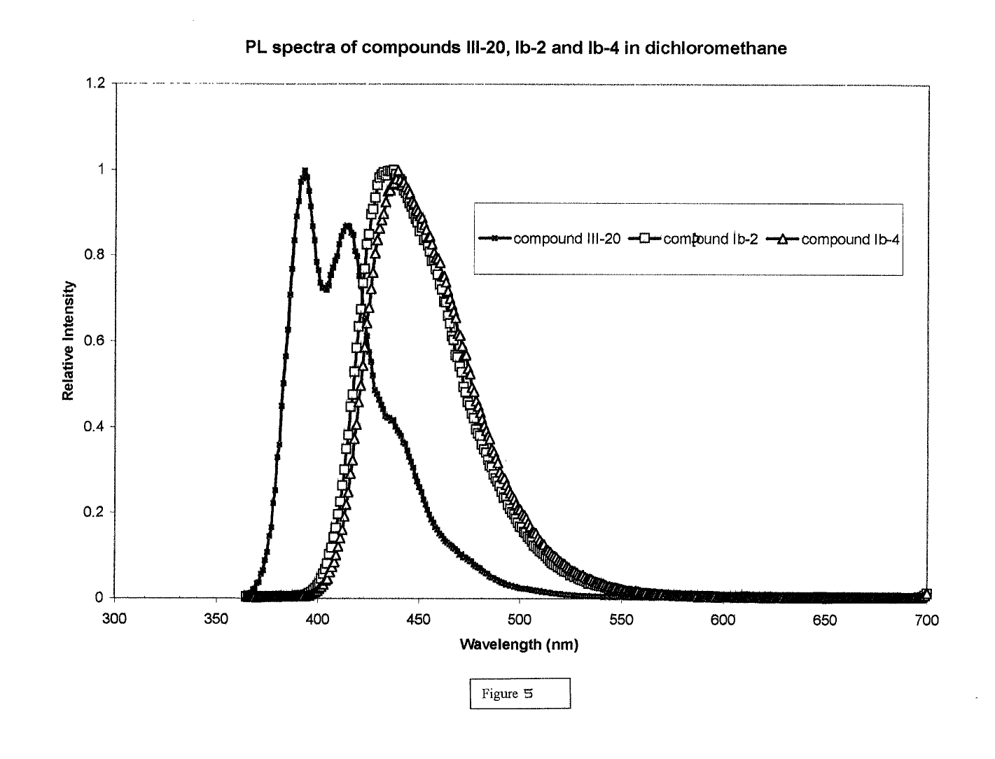

In another embodiment as illustrated in FIG. 3, the light emitting diode is comprised of a supporting substrate 2 of, for example, glass, an anode 3, an aromatic amines of the formulas illustrated herein, organic hole transporting zone 4, a light emitting layer 5b formed by deposition of pure luminescent materials or co-deposition luminescent host and another luminescent material as a luminescent dopand, an organic electron transporting zone 5a, and in contact therewith a cathode 6.

Illustrative examples of supporting substrates include polymeric components, glass and the like, and polyesters like MYLAR.RTM., polycarbonates, polyacrylates, polymethacrylates, polysulfones, quartz, and the like. Other substrates can be selected provided, for example, that they are essentially nonfunctional and can support the other layers. The thickness of the substrates can be, for example, from about 25 to about 1,000 microns or more, and preferably, from about 50 to about 6,000 microns depending, for example, on the structural demands of the device.

Examples of the anode contiguous to the substrate include positive charge injecting electrodes such as indium tin oxide, tin oxide, gold, platinum, or other materials, such as electrically conductive carbon, conjugated polymers such as polyaniline, polypyrrole, and the like, with, for example, a work function equal to, or greater than about 4 electron volts, and more specifically, from about 4 to about 6 electron volts. The thickness of the anode can range from about 10 to about 5,000 Angstroms with the preferred range being dictated by the optical constants of the anode material. One preferred range of thickness is from about 20 to about 1,000 Angstroms (Angstroms).

The commonly used hole transport materials are triaryl amines or a mixture of amines, such as:

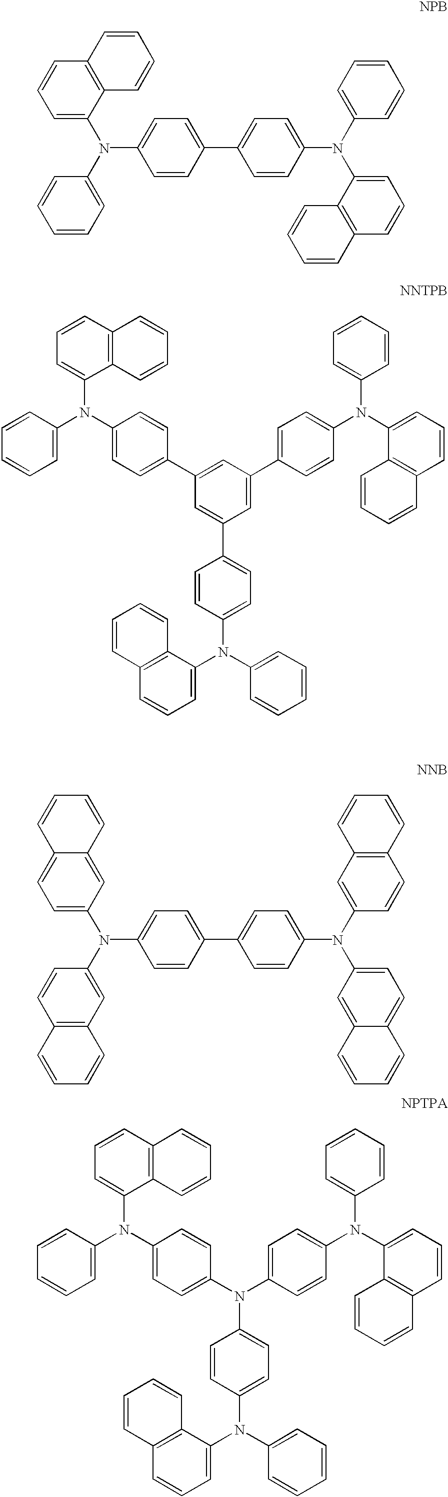

Other preferred materials for use in forming the hole injecting and transporting zone of the EL devices are comprised of a mixture of isomeric aromatic amines represented by the following Formula (1)

[(A₁)ₐ+(A₂)_{b}+ - - - +(Aₙ)ₓ] (1)

wherein:

A₁, A₂, and Aₙ represent individual components of the mixture of isomeric aromatic amines; these isomeric amines contain at least 24 carbon atoms and have a general molecular formula (2):

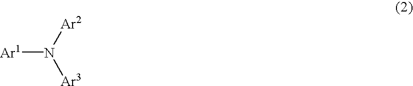

Wherein:

Ar¹ is an aryl group or substituted aryl group containing at least 18 carbon atoms; Ar² and Ar³ are individual aryl groups or substituted aryl groups containing at least 6 carbon atoms;

Each individual component (A₁, A₂, . . . and Aₙ) in the mixture has the same molecular formula. The difference of the individual component is the sequences of their atoms, or the point of attachment of substituents;

a, b, - - - and x are the ratio of each of the components A₁, A₂, . . . Aₙ in the mixture, range from 0 to 100%. The sum of a, b, - - - x is 1.

The following examples represent a mixture of this isomeric aromatic amine used in EL devices comprising NPPX and NPBX.

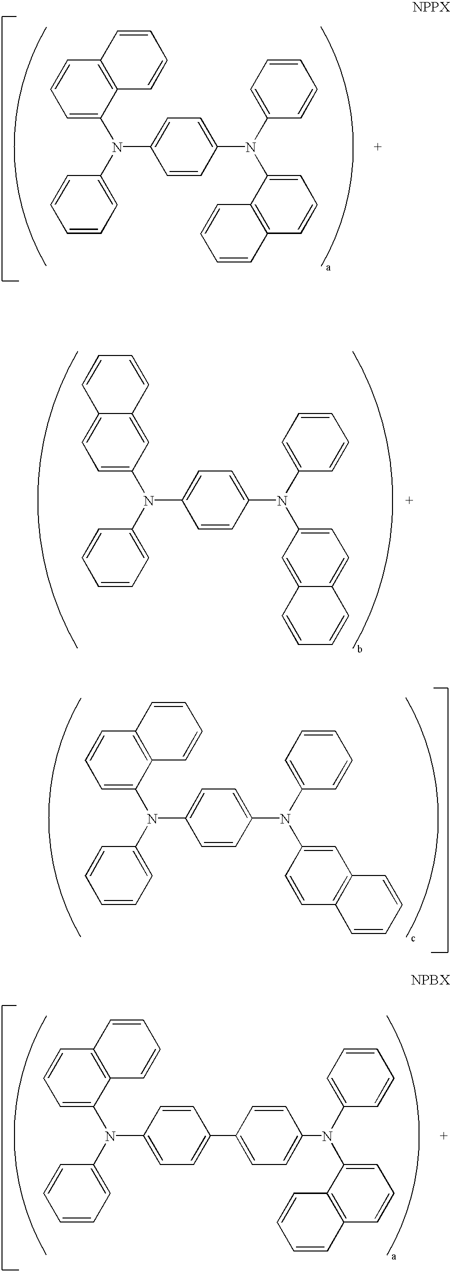

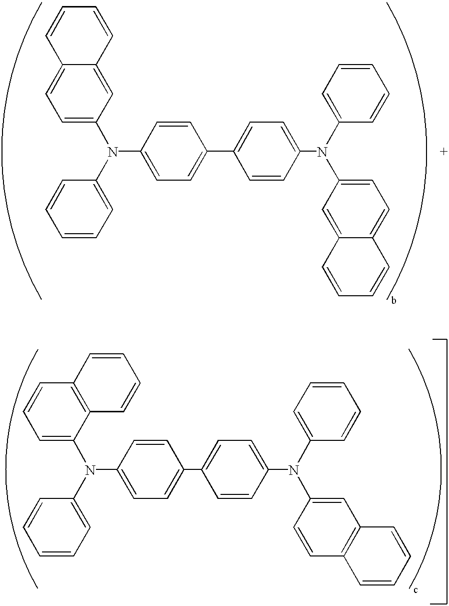

Wherein:

a, b, and c are the ratio of each of the components in the isomeric mixture, range from 0 to 100%. The sum of a, b, and c is 1.

These isomeric mixture aryl amines have advantages in improving thin film morphology properties, as a result, pinholes in the EL devices can be significantly reduced.

The electron injecting and transporting zone in the EL devices of the present invention can be comprised of any conventional electron injecting and transporting compound or compounds. Examples of useful electron transport compounds include fused ring luminescent materials such as anthracene, pentathrecene, pyrene, perylene, and the like, as illustrated by U.S. Pat. No. 3,172,862; butadienes such as 1,4-diphenylbutadiene and tetraphenylbutadiene, and stilbenes, and the like, as illustrated in U.S. Pat. Nos. 4,356,429 and 5,516,577; optical brighteners such as those disclosed by U.S. Pat. No. 4,539,507, the disclosures of which are totally incorporated herein by reference.

The light-emitting layer of the organic EL medium comprises a luminescent or fluorescent material wherein electroluminescence is produced as a result of electron-hole pair recombination in this region. In the practice of the present invention, the simplest construction comprises a single component material forming the light-emitting layer, which comprises of an anthracene derivative or a mixture of anthracene derivatives represented by the general structural Formula:

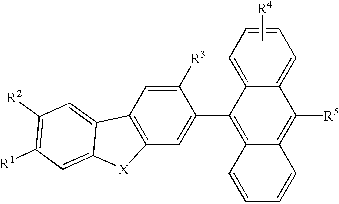

wherein:

R¹, R², R³ and R⁴ are hydrogen, alkyl, or alkoxyl groups containing 1 to 16 carbon atoms, alkenyl groups containing at least one carbon-carbon double bond, aryl or substituted aryl group containing 6 to 24 carbon atoms, heteroaryl or substituted heteroaryl group containing 5 to 24 carbon atoms, amino group, N-alkylamino group, N-arylamino group, N,N-dialkylamino group, N,N-diaryl group, cyano group, perfluoroalkyl group containing 1-8 carbon atoms, chlorine, bromine, and fluorine;

R⁵ is alkyl group or perfluoroalkyl group containing 1 to 16 carbon atoms; aryl or substituted aryl group containing 6 to 40 carbon atoms; heteroaryl or substituted heteroaryl group containing 5 to 40 carbon atoms, and cyano group, chlorine, bromine, and fluorine.

X is methylene group, dialkyl methylene and diaryl methylene groups, hetero atom such as oxygen, sulfur, or alkyl or aryl substituted amino groups, or dialkyl or diaryl substituted silyl groups;

Representative examples of anthracene derivatives in accordance with the invention include those illustrated as follows. The following Examples are provided to further define various species of the present invention. It is noted that these examples are intended to illustrate but not to limit the scope of the present invention. When X is a methylene group, a dialkyl methylene or diaryl methylene group, the structural formula is preferably the following formula Ia.

| | |
|---|---|
| 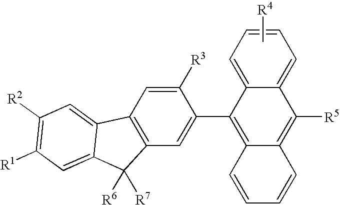 | Ia |

| Compounds | R¹ | R², R³ | R⁴ | R⁵ | R⁶ | R⁷ |
|---|---|---|---|---|---|---|
| Ia-1 | H | H | H | -Ph | -Me | -Me |
| Ia-2 | H | H | H | -Ph | -Et | -Et |
| Ia-3 | H | H | t-Bu | -Ph | -Me | -Me |
| Ia-4 | H | H | t-Bu | -Ph | -Et | -Et |
| Ia-5 | H | H | H | 2-naphthyl | -Me | -Me |
| Ia-6 | H | H | H | 2-naphthyl | -Et | -Et |
| Ia-7 | H | H | t-Bu | 2-naphthyl | -Me | -Me |
| Ia-8 | H | H | t-Bu | 2-naphthyl | -Et | -Et |
| Ia-9 | H | H | H | CF₃ | -Me | -Me |
| Ia-10 | H | H | H | CF₃ | -Et | -Et |
| Ia-11 | H | H | t-Bu | CF₃ | -Me | -Me |
| Ia-12 | H | H | t-Bu | CF₃ | -Et | -Et |
| Ia-13 | H | H | H | CN | -Me | -Me |
| Ia-14 | H | H | H | CN | -Et | -Et |
| Ia-15 | H | H | t-Bu | CN | -Me | -Me |
| Ia-16 | H | H | t-Bu | CN | -Et | -Et |
| Ia-17 | NPh₂ | H | H | CF₃ | -Me | -Me |
| Ia-18 | NPh₂ | H | H | CF₃ | -Et | -Et |
| Ia-19 | NPh₂ | H | t-Bu | CF₃ | -Me | -Me |
| Ia-20 | NPh₂ | H | t-Bu | CF₃ | -Et | -Et |
| Ia-21 | NPh₂ | H | H | CN | -Me | -Me |
| Ia-22 | NPh₂ | H | H | CN | -Et | -Et |
| Ia-23 | NPh₂ | H | t-Bu | CN | -Me | -Me |
| Ia-24 | NPh₂ | H | t-Bu | CN | -Et | -Et |
| Ia-25 | NPh₂ | H | H | -Ph | -Me | -Me |
| Ia-26 | NPh₂ | H | H | -Ph | -Et | -Et |
| Ia-27 | NPh₂ | H | t-Bu | -Ph | -Me | -Me |
| Ia-28 | NPh₂ | H | t-Bu | -Ph | -Et | -Et |
| Ia-29 | NPh₂ | H | H | 2-naphthyl | -Me | -Me |
| Ia-30 | NPh₂ | H | H | 2-naphthyl | -Et | -Et |
| Ia-31 | NPh₂ | H | t-Bu | 2-naphthyl | -Me | -Me |
| Ia-32 | NPh₂ | H | t-Bu | 2-naphthyl | -Et | -Et |
| Ia-33 | H | H | H | -Ph | -Bu | -Bu |
| Ia-34 | H | H | t-Bu | -Ph | -Bu | -Bu |
| Ia-35 | H | H | H | 2-naphthyl | -Bu | -Bu |
| Ia-36 | H | H | t-Bu | 2-naphthyl | -Bu | -Bu |
| Ia-37 | H | H | H | CF₃ | -Bu | -Bu |
| Ia-38 | H | H | t-Bu | CF₃ | -Bu | -Bu |
| Ia-39 | H | H | H | CN | -Bu | -Bu |
| Ia-40 | H | H | t-Bu | CN | -Bu | -Bu |
| Ia-41 | NPh₂ | H | H | CF₃ | -Bu | -Bu |
| Ia-42 | NPh₂ | H | t-Bu | CF₃ | -Bu | -Bu |
| Ia-43 | NPh₂ | H | H | CN | -Bu | -Bu |
| Ia-44 | NPh₂ | H | t-Bu | CN | -Bu | -Bu |
| Ia-45 | NPh₂ | H | H | -Ph | -Bu | -Bu |
| Ia-46 | NPh₂ | H | t-Bu | -Ph | -Bu | -Bu |
| Ia-47 | NPh₂ | H | H | 2-naphthyl | -Bu | -Bu |
| Ia-48 | NPh₂ | H | t-Bu | 2-naphthyl | -Bu | -Bu |

when R⁵ is

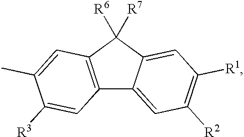

more favorable molecular structure of formula I becomes more typically formula Ib.

Ib

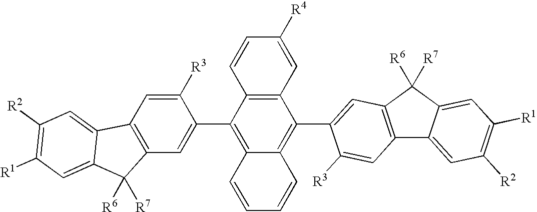

| Compounds | R¹ | R², R³ | R⁴ | R⁶ | R⁷ |
|---|---|---|---|---|---|
| Ib-1 | H | H | H | -Me | -Me |
| Ib-2 | H | H | H | -Et | -Et |
| Ib-3 | H | H | t-Bu | -Me | -Me |
| lb-4 | H | H | t-Bu | -Et | -Et |
| Ib-5 | NPh₂ | H | H | -Me | -Me |
| Ib-6 | NPh₂ | H | H | -Et | -Et |
| Ib-7 | NPh₂ | H | t-Bu | -Me | -Me |
| Ib-8 | NPh₂ | H | t-Bu | -Et | -Et |
| Ib-9 | Ph | H | H | -Me | -Me |
| Ib-10 | Ph | H | H | -Et | -Et |
| Ib-11 | Ph | H | t-Bu | -Me | -Me |
| Ib-12 | Ph | H | t-Bu | -Et | -Et |
| Ib-13 | H | H | H | -Bu | -Bu |
| Ib-14 | H | H | t-Bu | -Bu | -Bu |
| Ib-15 | NPh₂ | H | H | -Bu | -Bu |
| Ib-16 | NPh₂ | H | t-Bu | -Bu | -Bu |
| Ib-17 | Ph | H | H | -Bu | -Bu |
| Ib-18 | Ph | H | t-Bu | -Bu | -Bu |
| Ib-19 | 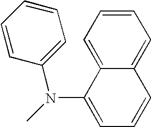 | H | H | -Me | -Me |
| Ib-20 | 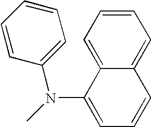 | H | H | -Et | -Et |
| Ib-21 | 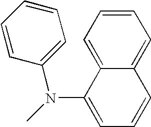 | H | t-Bu | -Me | -Me |
| Ib-22 | 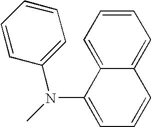 | H | t-Bu | -Et | -Et |
| Ib-23 | 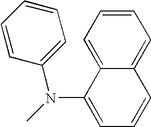 | H | H | -Bu | -Bu |
| Ib-24 | 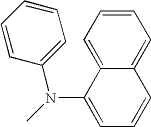 | H | t-Bu | -Bu | -Bu |

when X is or alkyl or aryl substituted amino groups, R⁵ is

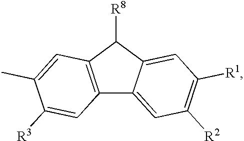

more favorable molecular structure of formula I becomes more typically formula Ic.

Ic

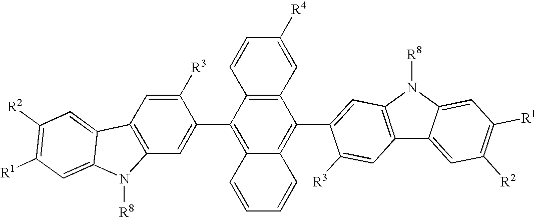

| Compounds | R¹ | R², R³ | R⁴ | R⁸ |
|---|---|---|---|---|
| Ic-1 | H | H | H | -Et |
| Ic-2 | H | H | H | -Ph |
| Ic-3 | H | H | H | 1-naphthyl |
| Ic-4 | H | H | H | 2-naphthyl |
| Ic-5 | H | H | t-Bu | -Et |
| Ic-6 | H | H | t-Bu | -Ph |
| Ic-7 | H | H | t-Bu | 1-naphthyl |
| Ic-8 | H | H | t-Bu | 2-naphthyl |
| Ic-9 | H | NPh₂ | H | -Et |
| Ic-10 | H | NPh₂ | H | -Ph |
| Ic-11 | H | NPh₂ | H | 1-naphthyl |
| Ic-12 | H | NPh₂ | H | 2-naphthyl |
| Ic-13 | H | NPh₂ | t-Bu | -Et |
| Ic-14 | H | NPh₂ | t-Bu | -Ph |
| Ic-15 | H | NPh₂ | t-Bu | 1-naphthyl |
| Ic-16 | H | NPh₂ | t-Bu | 2-naphthyl |
| Ic-17 | 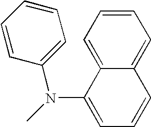 | H | H | -Et |
| Ic-18 | 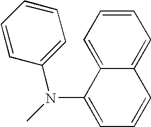 | H | H | -Ph |
| Ic-19 | 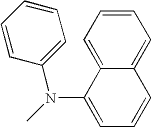 | H | H | 1-naphthyl |
| Ic-20 | 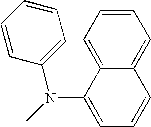 | H | H | 2-naphthyl |
| Ic-21 | 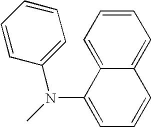 | H | t-Bu | -Et |
| Ic-22 | 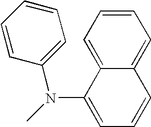 | H | t-Bu | -Ph |
| Ic-23 | 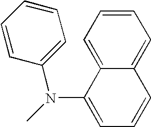 | H | t-Bu | 1-naphthyl |
| Ic-24 | 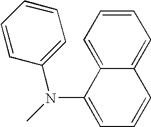 | H | t-Bu | 2-naphthyl |
| Ic-25 | H | 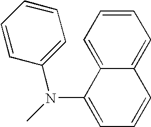 | H | -Et |
| Ic-26 | H | 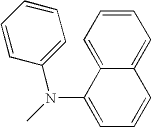 | H | -Ph |
| Ic-27 | H | 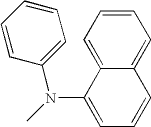 | H | 1-naphth |
| Ic-28 | H | 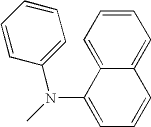 | H | 2-naphthyl |
| Ic-29 | H | 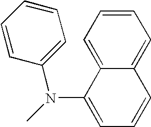 | t-Bu | -Et |
| Ic-30 | H | 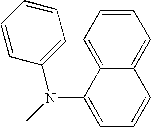 | t-Bu | -Ph |
| Ic-31 | H | 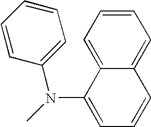 | t-Bu | 1-naphthyl |
| Ic-32 | H | 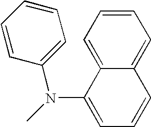 | t-Bu | 2-naphthyl |

A preferred embodiment of the luminescent layer comprises multi-component materials consisting of a host material doped with one or more components of fluorescent dyes or electron trapping agents. Using this method, highly efficient EL devices can be constructed. Simultaneously, the color of the EL devices can be tuned by using fluorescent dyes of different emission wavelengths in a common host material. This dopant scheme has been described in considerable detail for EL devices using Alq as the host material by Tang et al. Applied Physics, Vol. 65, Pages 3610-3616, 1989; U.S. Pat. No 4,769,292.

The novel anthracene derivatives of this invention have sufficiently large bandgaps for effective energy transfer with a range of commonly available fluorescent dyes as dopants. Examples of such blue dopants include arylamines, coumarins, stilbenes, distrylstilbenes, anthracene derivatives, tetracene, perylene, and other conjugated benzenoids. Other dopants for EL emissions at longer wavelengths include rubrene, quinacrydone and other green or red emitting fluorescent dyes.

In the present invention, preferred embodiment dopands are novel coumarin derivatives represented by the following Formula II.

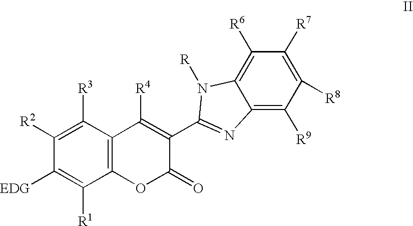

Wherein:

R is hydrogen, alkyl of from 1-24 carbon atoms, aryl, hereoaryl or carbocyclic systems;

R¹, R², R³, R⁴, R⁵, R⁶, R⁷, R⁸ and R⁹ are individually alkyl of from 1 to 20 carbon atoms, aryl or carbocyclic systems;

EDG is hydrogen, alkyl group of from 1-24 carbon atoms, aryl group of from 5-24 carbon atoms, or electron donating groups, more typically are:

—OR¹⁰

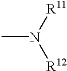

Wherein:

R¹⁰, R¹¹ and R¹² are individually alkyl of from 1 to 20 carbon atoms, aryl or carbocyclic systems; R¹¹ and R¹, R¹¹ and R¹², and R¹² and R² taken together can form ring systems, such as piperidine, julolidine, or tetramethyljulolidine;

The following is a list of guest molecules, functioning as fluorescent sensitizing dyes, which are contemplated for use in the practice of the invention. Representative examples of coumarin derivatives in accordance with the invention include those illustrated as follows. The following examples are provided to further define various species of the present invention. It is noted that these examples are intended to illustrate but not limit the scope of the present invention.

| | |
|---|---|
| 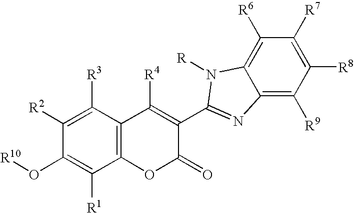 | IIa |

| Comps. No. | R | R¹ ˜ R⁶ | R⁷ | R⁸ | R⁹ | R¹⁰ |
|---|---|---|---|---|---|---|
| IIa-1 | -Me | H | H | H | H | -Me |
| IIa-2 | -Me | H | H | H | H | -Et |
| IIa-3 | -Me | H | H | H | H | -isopropyl |
| IIa-4 | -Me | H | H | H | H | -butyl |
| IIa-5 | -Me | H | H | H | H | -t-butyl |
| IIa-6 | -Me | H | H | H | H | Ph |
| IIa-7 | -Et | H | H | H | H | -Me |
| IIa-8 | -Et | H | H | H | H | -Et |
| IIa-9 | -Et | H | H | H | H | -isopropyl |
| IIa-10 | -Et | H | H | H | H | -butyl |
| IIa-11 | -Et | H | H | H | H | -t-butyl |
| IIa-12 | -Et | H | H | H | H | Ph |
| IIa-13 | Ph | H | H | H | H | -Me |
| IIa-14 | Ph | H | H | H | H | -Et |
| IIa-15 | Ph | H | H | H | H | -isopropyl |
| IIa-16 | Ph | H | H | H | H | -butyl |
| IIa-17 | Ph | H | H | H | H | -t-butyl |
| IIa-18 | Ph | H | H | H | H | Ph |
| IIa-19 | 1-Naphthyl | H | H | H | H | -Me |
| IIa-20 | 1-Naphthyl | H | H | H | H | -Et |
| IIa-21 | 1-Naphthyl | H | H | H | H | -isopropyl |
| IIa-22 | 1-Naphthyl | H | H | H | H | -butyl |
| IIa-23 | 1-Naphthyl | H | H | H | H | -t-butyl |
| IIa-24 | 1-Naphthyl | H | H | H | H | Ph |
| IIa-25 | p-biphenylyl | H | H | H | H | -Me |
| IIa-26 | p-biphenylyl | H | H | H | H | -Et |
| IIa-27 | p-biphenylyl | H | H | H | H | -isopropyl |
| IIa-28 | p-biphenylyl | H | H | H | H | -butyl |
| IIa-29 | p-biphenylyl | H | H | H | H | -t-butyl |
| IIa-30 | p-biphenylyl | H | H | H | H | Ph |
| IIa-31 | -Me | H | -t-butyl | H | H | -Me |
| IIa-32 | -Me | H | -t-butyl | H | H | -Et |
| IIa-33 | -Me | H | -t-butyl | H | H | -isopropyl |
| IIa-34 | -Me | H | -t-butyl | H | H | -butyl |
| IIa-35 | -Me | H | -t-butyl | H | H | -t-butyl |
| IIa-36 | -Me | H | -t-butyl | H | H | Ph |
| IIa-37 | -Et | H | H | H | -t-butyl | -Me |
| IIa-38 | -Et | H | H | H | -t-butyl | -Et |
| IIa-39 | -Et | H | H | H | -t-butyl | -isopropyl |
| IIa-40 | -Et | H | H | H | -t-butyl | -butyl |
| IIa-41 | -Et | H | H | H | -t-butyl | -t-butyl |
| IIa-42 | -Et | H | H | H | -t-butyl | Ph |
| IIa-43 | Ph | H | -t-butyl | H | -t-butyl | -Me |
| IIa-44 | Ph | H | -t-butyl | H | -t-butyl | -Et |
| IIa-45 | Ph | H | -t-butyl | H | -t-butyl | -isopropyl |
| IIa-46 | Ph | H | -t-butyl | H | -t-butyl | -butyl |
| IIa-47 | Ph | H | -t-butyl | H | -t-butyl | -t-butyl |
| IIa-48 | Ph | H | -t-butyl | H | -t-butyl | Ph |

| | |
|---|---|
| 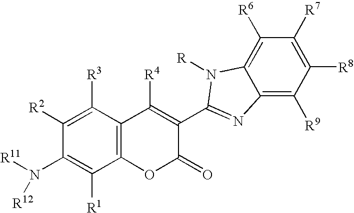 | IIb |

| Comps. No. | R | R¹ ˜ R⁶ | R⁷ | R⁸ | R⁹ | R¹¹ | R¹² |
|---|---|---|---|---|---|---|---|
| IIb-1 | m-tolyl | H | H | H | H | -Me | -Me |
| IIb-2 | m-tolyl | H | H | H | H | -Et | -Et |
| IIb-3 | m-tolyl | H | H | H | H | -Butyl | -Butyl |
| IIb-4 | m-tolyl | H | H | H | H | -Me | Ph |
| IIb-5 | m-tolyl | H | H | H | H | Ph | Ph |
| IIb-6 | m-tolyl | H | H | H | H | p-tolyl | p-tolyl |
| IIb-7 | -Et | H | H | H | H | -Me | -Me |
| IIb-8 | -Et | H | H | H | H | -Et | -Et |
| IIb-9 | -Et | H | H | H | H | -Butyl | -Butyl |
| IIb-10 | -Et | H | H | H | H | -Me | Ph |
| IIb-11 | -Et | H | H | H | H | Ph | Ph |
| IIb-12 | -Et | H | H | H | H | p-tolyl | p-tolyl |
| IIb-13 | Ph | H | H | H | H | -Me | -Me |
| IIb-14 | Ph | H | H | H | H | -Et | -Et |
| IIb-15 | Ph | H | H | H | H | -Butyl | -Butyl |
| IIb-16 | Ph | H | H | H | H | -Me | Ph |
| IIab-17 | Ph | H | H | H | H | Ph | Ph |
| IIb-18 | Ph | H | H | H | H | p-tolyl | p-tolyl |
| IIb-19 | 1-Naphthyl | H | H | H | H | -Me | -Me |
| IIb-20 | 1-Naphthyl | H | H | H | H | -Et | -Et |
| IIb-21 | 1-Naphthyl | H | H | H | H | -Butyl | -Butyl |
| IIb-22 | 1-Naphthyl | H | H | H | H | -Me | Ph |
| IIb-23 | 1-Naphthyl | H | H | H | H | Ph | Ph |
| IIb-24 | 1-Naphthyl | H | H | H | H | p-tolyl | p-tolyl |
| IIb-25 | p-biphenylyl | H | H | H | H | -Me | -Me |
| IIb-26 | p-biphenylyl | H | H | H | H | -Et | -Et |
| IIb-27 | p-biphenylyl | H | H | H | H | -Butyl | -Butyl |
| IIb-29 | p-biphenylyl | H | H | H | H | Ph | Ph |
| IIb-30 | p-biphenylyl | H | H | H | H | p-tolyl | p-tolyl |
| IIb-31 | -Butyl | H | t-butyl | H | H | -Me | -Me |
| IIb-32 | -Butyl | H | t-butyl | H | H | -Et | -Et |
| IIb-33 | -Butyl | H | t-butyl | H | H | -Butyl | -Butyl |
| IIb-34 | -Butyl | H | t-butyl | H | H | -Me | Ph |
| IIb-35 | -Butyl | H | t-butyl | H | H | Ph | Ph |
| IIb-36 | -Butyl | H | t-butyl | H | H | p-tolyl | p-tolyl |
| IIb-37 | p-tolyl | H | H | H | t-butyl | -Me | -Me |
| IIb-38 | p-tolyl | H | H | H | t-butyl | -Et | -Et |
| IIb-39 | p-tolyl | H | H | H | t-butyl | -Butyl | -Butyl |
| IIb-40 | p-tolyl | H | H | H | t-butyl | -Me | Ph |
| IIb-41 | p-tolyl | H | H | H | t-butyl | Ph | Ph |
| IIb-42 | p-tolyl | H | H | H | t-butyl | p-tolyl | p-tolyl |
| IIb-43 | Ph | H | t-butyl | H | t-butyl | -Me | -Me |
| IIb-44 | Ph | H | t-butyl | H | t-butyl | -Et | -Et |
| IIb-45 | Ph | H | t-butyl | H | t-butyl | -Butyl | -Butyl |
| IIIb-46 | Ph | H | t-butyl | H | t-butyl | -Me | Ph |
| IIb-47 | Ph | H | t-butyl | H | t-butyl | Ph | Ph |
| IIb-48 | Ph | H | t-butyl | H | t-butyl | p-tolyl | p-tolyl |

| 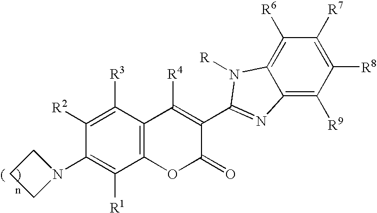 | | | | | | IIc |
|---|---|---|---|---|---|---|
| Comps. No. | R | R¹ ˜ R⁶ | R⁷ | R⁸ | R⁹ | n |
| IIc-1 | m-tolyl | H | H | H | H | 1 |
| IIc-2 | m-tolyl | H | t-butyl | H | H | 1 |
| IIc-3 | m-tolyl | H | H | t-butyl | H | 1 |
| IIc-4 | m-tolyl | H | H | H | H | 2 |
| IIc-5 | m-tolyl | H | t-butyl | H | H | 2 |
| IIc-6 | m-tolyl | H | H | t-butyl | H | 2 |
| IIc-7 | -Et | H | H | H | H | 1 |
| IIc-8 | -Et | H | t-butyl | H | H | 1 |
| IIc-9 | -Et | H | H | t-butyl | H | 1 |
| IIe-10 | -Et | H | H | H | H | 2 |
| IIc-11 | -Et | H | t-butyl | H | H | 2 |
| IIc-12 | -Et | H | H | t-butyl | H | 2 |
| IIc-13 | Ph | H | H | H | H | 1 |
| IIIc-14 | Ph | H | t-butyl | H | H | 1 |
| IIc-15 | Ph | H | H | t-butyl | H | 1 |
| IIc-16 | Ph | H | H | H | H | 2 |
| IIc-17 | Ph | H | t-butyl | H | H | 2 |
| IIc-18 | Ph | H | H | t-butyl | H | 2 |
| IIc-19 | 1-Naphthyl | H | H | H | H | 1 |
| IIc-20 | 1-Naphthyl | H | t-butyl | H | H | 1 |
| IIc-21 | 1-Naphthyl | H | H | t-butyl | H | 1 |
| IIc-22 | 1-Naphthyl | H | H | H | H | 2 |
| IIc-23 | 1-Naphthyl | H | t-butyl | H | H | 2 |
| IIc-24 | 1-Naphthyl | H | H | t-butyl | H | 2 |
| IIc-25 | p-biphenylyl | H | H | H | H | 1 |
| IIc-26 | p-biphenylyl | H | t-butyl | H | H | 1 |
| IIc-27 | p-biphenylyl | H | H | t-butyl | H | 1 |
| IIc-28 | p-biphenylyl | H | H | H | H | 2 |
| IIc-29 | p-biphenylyl | H | t-butyl | H | H | 2 |
| IIc-30 | p-biphenylyl | H | H | t-butyl | H | 2 |
| IIc-31 | -Butyl | H | H | H | H | 1 |
| IIc-32 | -Butyl | H | -t-butyl | H | H | 1 |
| IIc-33 | -Butyl | H | H | -t-butyl | H | 1 |
| IIc-34 | -Butyl | H | H | H | H | 2 |
| IIc-35 | -Butyl | H | -t-butyl | H | H | 2 |
| IIc-36 | -Butyl | H | H | -t-butyl | H | 2 |
| IIc-37 | p-tolyl | H | H | H | H | 1 |
| IIc-38 | p-tolyl | H | -t-butyl | H | H | 1 |
| IIc-39 | p-tolyl | H | H | -t-butyl | H | 1 |
| IIc-40 | p-tolyl | H | H | H | H | 2 |
| IIc-41 | p-tolyl | H | -t-butyl | H | H | 2 |
| IIc-42 | p-tolyl | H | H | -t-butyl | H | 2 |

| | |
|---|---|
| 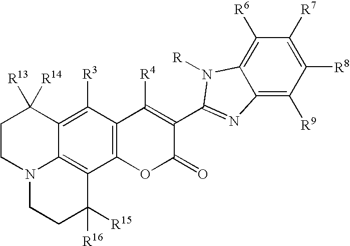 | IId |

| Comps. No. | R | R³ ˜ R⁶ | R⁷ | R⁸ | R⁹ | R¹³ ˜ R¹⁶ |
|---|---|---|---|---|---|---|
| IId-1 | m-tolyl | H | H | H | H | H |
| IId-2 | m-tolyl | H | t-butyl | H | H | H |
| IId-3 | m-tolyl | H | H | t-butyl | H | H |
| IId-4 | m-tolyl | H | H | H | H | Me |
| IId-5 | m-tolyl | H | t-butyl | H | H | Me |
| IId-6 | m-tolyl | H | H | t-butyl | H | Me |
| IId-7 | -Et | H | H | H | H | H |
| IId-8 | -Et | H | t-butyl | H | H | H |
| IId-9 | -Et | H | H | t-butyl | H | H |
| lId-10 | -Et | H | H | H | H | Me |
| Ild-11 | -Et | H | t-butyl | H | H | Me |
| lId-12 | -Et | H | H | t-butyl | H | Me |
| IId-13 | Ph | H | H | H | H | H |
| IId-14 | Ph | H | t-butyl | H | H | H |
| IId-15 | Ph | H | H | t-butyl | H | H |
| IId-16 | Ph | H | H | H | H | Me |
| IId-17 | Ph | H | t-butyl | H | H | Me |
| IId-18 | Ph | H | H | t-butyl | H | Me |
| IId-19 | 1-Naphthyl | H | H | H | H | H |
| IId-20 | 1 -Naphthyl | H | t-butyl | H | H | H |
| IId-21 | 1-Naphthyl | H | H | t-butyl | H | H |
| IId-22 | 1-Naphthyl | H | H | H | H | Me |
| IId-23 | 1-Naphthyl | H | t-butyl | H | H | Me |
| IId-24 | 1-Naphthyl | H | H | t-butyl | H | Me |
| IId-25 | p-biphenylyl | H | H | H | H | H |
| IId-26 | p-biphenylyl | H | t-butyl | H | H | H |
| IId-27 | p-biphenylyl | H | H | t-butyl | H | H |
| IId-28 | p-biphenylyl | H | H | H | H | Me |
| IId-29 | p-biphenylyl | H | t-butyl | H | H | Me |
| IId-30 | p-biphenylyl | H | H | t-butyl | H | Me |
| IId-31 | -Butyl | H | H | H | H | H |
| IId-32 | -Butyl | H | -t-butyl | H | H | H |
| IId-33 | -Butyl | H | H | -t-butyl | H | H |
| IId-34 | -Butyl | H | H | H | H | Me |
| IId-35 | -Butyl | H | -t-butyl | H | H | Me |
| IId-36 | -Butyl | H | H | -t-butyl | H | Me |
| IId-37 | p-tolyl | H | H | H | H | H |
| IId-38 | p-tolyl | H | -t-butyl | H | H | H |
| IId-39 | p-tolyl | H | H | -t-butyl | H | H |
| IId-40 | p-tolyl | H | H | H | H | Me |
| IId-41 | p-tolyl | H | -t-butyl | H | H | Me |
| IId-42 | p-tolyl | H | H | -t-butyl | H | Me |

IIe

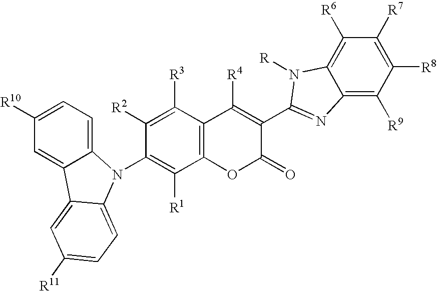

| Comps. No. | R | R¹ ˜ R⁶ | R⁷ | R⁸ | R⁹ | R¹⁰ ˜ R¹¹ |
|---|---|---|---|---|---|---|
| IIe-1 | m-tolyl | H | H | H | H | H |
| IIe-2 | m-tolyl | H | t-butyl | H | H | H |
| IIe-3 | m-tolyl | H | H | t-butyl | H | H |
| IIe-4 | m-tolyl | H | H | H | H | Me |
| IIe-5 | m-tolyl | H | t-butyl | H | H | Me |
| IIe-6 | m-tolyl | H | H | t-butyl | H | Me |
| IIe-7 | -Et | H | H | H | H | H |
| IIe-8 | -Et | H | t-butyl | H | H | H |
| IIe-9 | -Et | H | H | t-butyl | H | H |
| IIe-10 | -Et | H | H | H | H | Me |
| IIe-11 | -Et | H | t-butyl | H | H | Me |
| IIe-12 | -Et | H | H | t-butyl | H | Me |
| IIe-13 | Ph | H | H | H | H | NPh2 |
| IIe-14 | Ph | H | t-butyl | H | H | NPh2 |
| IIe-15 | Ph | H | H | t-butyl | H | NPh2 |
| IIe-16 | Ph | H | H | H | H | H |
| IIe-17 | Ph | H | t-butyl | H | H | H |
| IIe-18 | Ph | H | H | t-butyl | H | H |
| IIe-19 | 1-Naphthyl | H | H | H | H | H |
| IIe-20 | 1-Naphthyl | H | t-butyl | H | H | H |
| IIe-21 | 1-Naphthyl | H | H | t-butyl | H | H |
| IIe-22 | 1-Naphthyl | H | H | H | H | Me |
| IIe-23 | 1-Naphthyl | H | t-butyl | H | H | Me |
| IIe-24 | 1-Naphthyl | H | H | t-butyl | H | Me |
| IIe-25 | p-biphenylyl | H | H | H | H | H |
| IIe-26 | p-biphenylyl | H | t-butyl | H | H | H |
| IIe-27 | p-biphenylyl | H | H | t-butyl | H | H |
| IIe-28 | p-biphenylyl | H | H | H | H | Me |
| IIe-29 | p-biphenylyl | H | t-butyl | H | H | Me |
| IIe-30 | p-biphenylyl | H | H | t-butyl | H | Me |
| IIe-31 | -Butyl | H | H | H | H | H |
| IIe-32 | -Butyl | H | -t-butyl | H | H | H |
| IIe-33 | -Butyl | H | H | -t-butyl | H | H |
| IIe-34 | -Butyl | H | H | H | H | Me |
| IIe-35 | -Butyl | H | -t-butyl | H | H | Me |
| IIe-36 | -Butyl | H | H | -t-butyl | H | Me |
| IIe-37 | p-tolyl | H | H | H | H | H |
| IIe-38 | p-tolyl | H | -t-butyl | H | H | H |
| IIe-39 | p-tolyl | H | H | -t-butyl | H | H |
| IIe-40 | p-tolyl | H | H | H | H | Me |
| IIe-41 | p-tolyl | H | -t-butyl | H | H | Me |
| IIe-42 | p-tolyl | H | H | -t-butyl | H | Me |

In the present invention, another class of preferred dopants or guest materials are novel class of anthracene derivatives. Such anthracene derivatives of this invention are represented by the following Formula III.

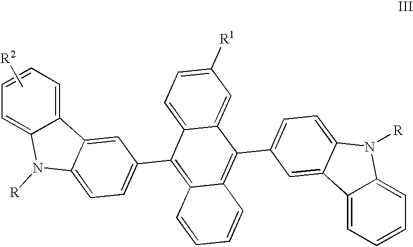

Wherein:

R¹ and R² are individually hydrogen, alkyl, or an aryl group of from 1 to 20 carbon atoms; R is hydrogen, or alkyl of from 1 to 24 carbon atoms, or aryl, or hereoaryl group of from 5 to 24 carbon atoms. Preferred examples are demonstrated but not limited to the following:

| Compounds | R | R¹ | R² |
|---|---|---|---|
| III-1 | H | H | H |
| III-2 | H | H | H |
| III-3 | H | t-Bu | H |
| III-4 | Me | H | H |
| III-5 | Me | H | H |
| III-6 | Me | t-Bu | H |
| III-7 | Ph | H | H |
| III-8 | Ph | H | H |
| III-9 | Ph | t-Bu | H |
| III-10 | 1-naphthyl | H | H |
| III-11 | 1-naphthyl | H | H |
| III-12 | 1-naphthyl | t-Bu | H |
| III-13 | 2-naphthyl | H | H |
| III-14 | 2-naphthyl | H | H |
| III-15 | 2-naphthyl | t-Bu | H |
| III-16 | Ph | 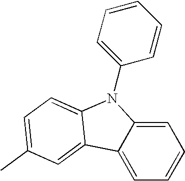 | 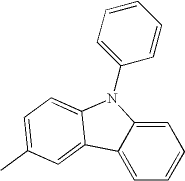 |
| III-17 | Ph | 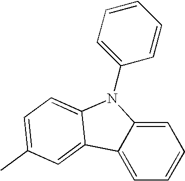 | 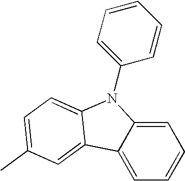 |
| III-18 | Ph | 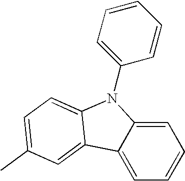 | 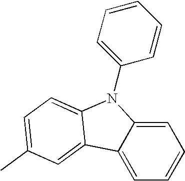 |

The following fluorescent dyes are also useful as dopants in the present invention.

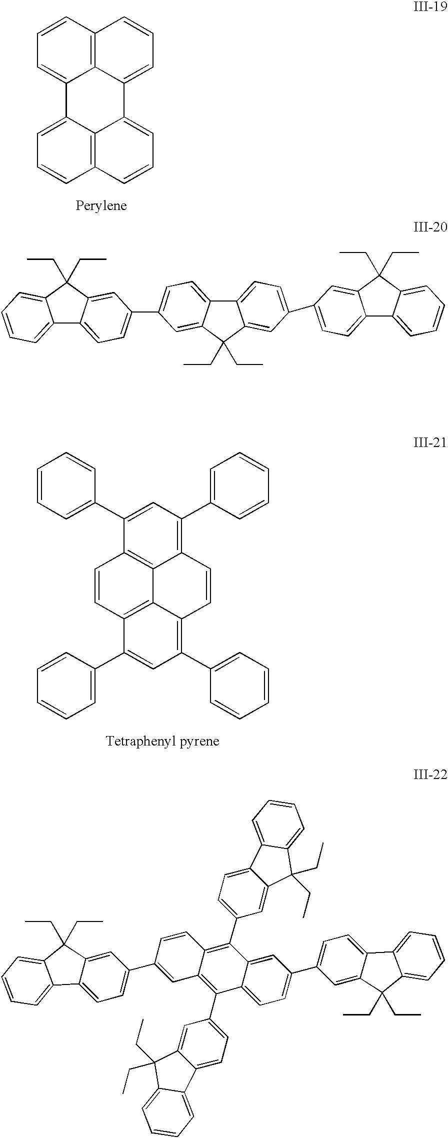

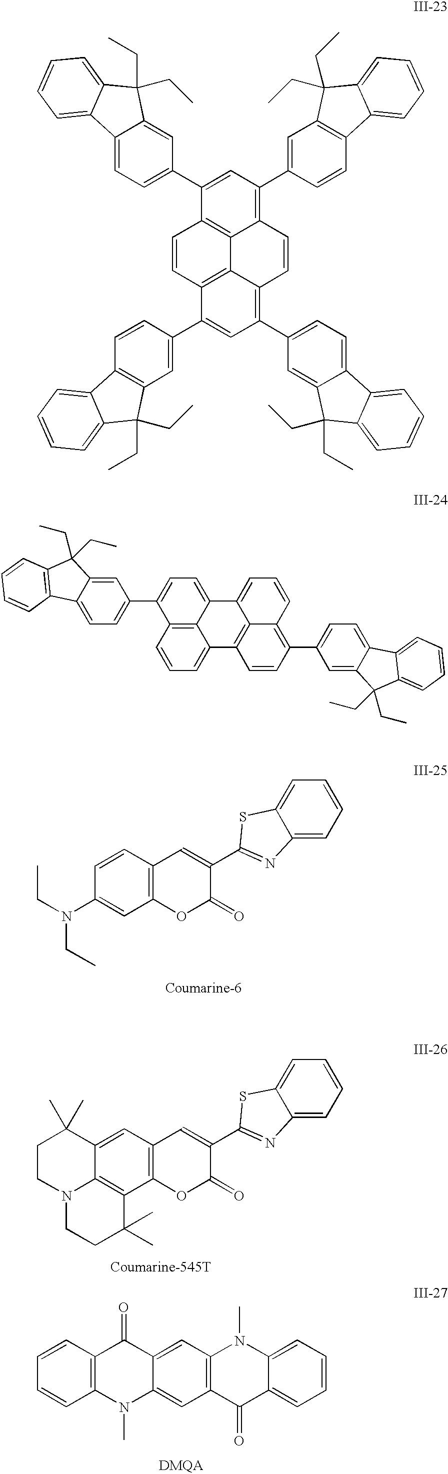

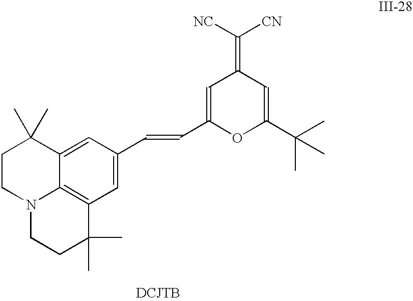

Preferred materials for using in forming an electron transporting layer of an EL medium comprises metal chelates of 8-hydroxyquinoline disclosed in U.S. Pat. Nos. 4,539,507; 5,151,629, and 5,150,006. Illustrative examples of the metal chelated compounds include tris(8-hydroxyquinolinate)aluminum (AIQ3), tris(8-hydroxyquinolinate) gallium, bis(8-hydroxyquinolinate)magnesium, bis(8-hydroxyquinolinate)zinc, tris(5-methyl-8-hydroxyquinolinate)aluminum, tris(7-propyl-8-quinolinolato)aluminum, bis-benzo-8-quinolinatezinc, bis(10-hydroxybenzoquinolinate)beryllium, bis(2-methylquinolinolato) aluminum(III)-.mu.-oxo-bis(2-methyl-8-quinolinolato) aluminum(III), bis(2-methyl-8-quinolinolato) (phenolato)aluminum, bis(2-methyl-8-quinolinolato) (para-phenylphenolato) aluminum, bis(2-methyl-8-quinolinolato)(2-naphthalolato)aluminum, and the like.

The disclosures of each of the above patents are totally incorporated herein by reference. Another class of preferred electron injecting and transporting compounds is metal thioxinoid compounds, disclosed in U.S. Pat. No. 5,648,542. Illustrative examples of metal thioxinoid compounds include bis(8-quinolinethiolato), bis(8-quinolinethiolato) cadmium, tris(8-quinolinethiolato)gallium, tris(8-quinolinethiolato)indium, bis(5-methylquinolinethiolato)zinc, tris(5-methylquinolinethiolato)gallium, tris(5-methylquinolinethiolato)indium, bis(5-methylquinolinethiolato) cadmium, bis(3-methylquinolinethiolato)cadmium, bis(5-methylquinolinethiolato)zinc, bisenzo-8-quinolinethiolato zinc, bis-methylbenzo-8-quinolinethiolatozinc, bis,7-dimethylbenzo-8-quinolinethiolato zinc, and the like.

Particularly preferred electron transport materials for using in forming an electron transporting layer of an EL medium comprises of benazole derivatives represented by the following Formula IV:

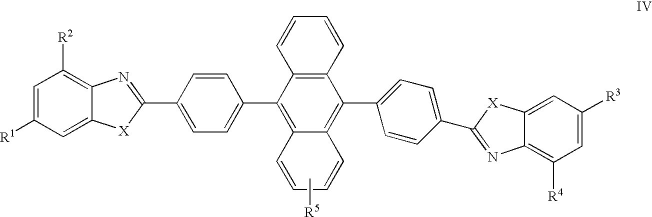

wherein:

R¹, R², R³, R⁴ and R⁵ are individual hydrogen, alkyl, or alkoxyl groups containing 1 to 16 carbon atoms, aryl or substituted aryl group containing 6 to 24 carbon atoms, heteroaryl or substituted heteroaryl group containing 5 to 24 carbon atoms;

X is methylene group, dialkyl methylene and diaryl methylene groups, S, O or NR, where R is hydrogen, alkyl, or alkoxyl groups containing 1 to 16 carbon atoms, aryl or substituted aryl group containing 6 to 24 carbon atoms.

Representative examples of this benazole derivatives IV in accordance with the invention include those illustrated as follows. The following Examples are provided to further define various species of the present invention. It is noted that these examples are intended to illustrate but not to limit the scope of the present invention.

| | |
|---|---|
| 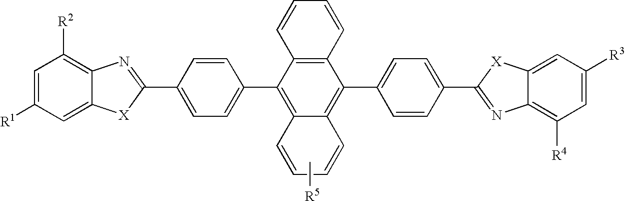 | IV |

| Compounds | R¹, R³ | R², R⁴ | X | R⁵ |
|---|---|---|---|---|
| IV-1 | H | H | O | H |
| IV-2 | H | H | O | t-Bu |
| IV-3 | H | t-Bu | O | H |
| IV-4 | H | t-Bu | O | t-Bu |
| IV-5 | t-Bu | H | O | H |
| IV-6 | t-Bu | H | O | t-Bu |
| IV-7 | t-Bu | t-Bu | O | H |
| IV-8 | t-Bu | t-Bu | O | t-Bu |
| IV-9 | H | H | S | H |
| IV-10 | H | H | S | t-Bu |
| IV-11 | H | t-Bu | S | H |
| IV-12 | H | t-Bu | S | t-Bu |
| IV-13 | t-Bu | H | S | H |
| IV-14 | t-Bu | H | S | t-Bu |
| IV-15 | t-Bu | t-Bu | S | H |
| IV-16 | t-Bu | t-Bu | S | t-Bu |
| IV-17 | H | H | -NMe | H |
| IV-18 | H | H | -NMe | t-Bu |
| IV-19 | H | t-Bu | -NMe | H |
| IV-20 | H | t-Bu | -NMe | t-Bu |
| IV-21 | t-Bu | H | -NMe | H |
| IV-22 | t-Bu | H | -NMe | t-Bu |
| IV-23 | t-Bu | t-Bu | -NMe | H |
| IV-24 | t-Bu | t-Bu | -NMe | t-Bu |
| IV-25 | H | H | -NPh | H |
| IV-26 | H | H | -NPh | t-Bu |
| IV-27 | H | t-Bu | -NPh | H |
| IV-28 | H | t-Bu | -NPh | t-Bu |
| IV-29 | t-Bu | H | -NPh | H |
| IV-30 | t-Bu | H | -NPh | t-Bu |
| IV-31 | t-Bu | t-Bu | -NPh | H |
| IV-32 | t-Bu | t-Bu | -NPh | t-Bu |
| IV-33 | H | H | -CMe2 | H |
| IV-34 | H | H | -CMe2 | t-Bu |
| IV-35 | H | t-Bu | -CMe2 | H |
| IV-36 | H | t-Bu | -CMe2 | t-Bu |
| IV-37 | t-Bu | H | -CMe2 | H |
| IV-38 | t-Bu | H | -CMe2 | t-Bu |
| IV-39 | t-Bu | t-Bu | -CMe2 | H |
| IV-40 | t-Bu | t-Bu | -CMe2 | t-Bu |

The benzole derivatives used as electron transport materials in forming electron transporting zone in EL devices have several advantages. They possess high electron mobility with good film forming properly. After vacuum evaporation, the benzole derivatives appear as an amorphous thin film with good thermal stability.

In embodiments of the present invention, the total thickness of the organic luminescent medium, which includes the hole injecting and transporting zone 4 and the electron injecting and transporting zone 5, is preferably, for example, less than about 1 micron, for example from about 0.05 to about 1 micron, to maintain a current density compatible with an efficient light emission under a relatively low voltage applied across the electrodes. Suitable thickness of the hole injecting and transporting layer 4 can range from about 50 to about 2,000 Angstrom, and preferably from about 400 to 1,000 Angstrom. Similarly, the thickness of the electron injecting and transporting layer 5 can range from about 50 to about 2,000 Angstrom, and preferably from about 400 to 1,000 Angstrom.

The cathode 6 can be comprised of any metal, including high or low work function metals. The cathode that can be derived from a combination of low work function metals, for example less than about 4 eV, and more specifically from about 2 to about 4V, and at least one second metal can provide additional advantages such as improved device performances and stability. Suitable proportions of the low work function metal to the second metal may range from less than about 0.1 percent to about 99.9 percent by weight, and in embodiments can be from about 1 to about 90 weight percent. Illustrative examples of low work function metals include alkaline metals, Group 2A or alkaline earth metals, and Group III metals including rare earth metals and the actinide group metals. Lithium, magnesium and calcium are particularly preferred.

The thickness of cathode 6 ranges from, for example, about 10 to about 5,000 Angstroms, and more specifically, from about 50 to about 250 Angstroms. The Mg:Ag cathodes of U.S. Pat. No. 4,885,211 constitute one preferred cathode construction. Another preferred cathode construction is described in U.S. Pat. No. 5,429,884, wherein the cathodes are formed from lithium alloys with other high work function metals such as aluminum and indium. The disclosures of each of the patents are totally incorporated herein by reference.

Both the anode 3 and cathode 6 of the organic EL devices of the present invention can be of any convenient form. A thin, for example about 200 Angstroms, conductive anode can be coated onto a light transmissive substrate, for example, a transparent or substantially transparent glass plate or plastic film. The EL device can include a light transmissive anode 3 formed from tin oxide or indium tin oxide coated on a glass plate. Also, very thin, for example less than 200 Angstroms, such as from about 50 to about 200 Angstroms light-transparent metallic anodes, can be selected, such as gold, palladium, and the like. In addition, transparent or semitransparent thin, for example 200 Angstroms, conjugated polymers, such as polyaniline, polypyrrole, and the like, can be selected as anodes. Further, suitable forms of the anode 3 and cathode 6 are illustrated by U.S. Pat. No. 4,885,211, the disclosure of which is totally incorporated herein by reference.

### EXAMPLES

The following Examples are provided to further define various species of the present invention. It is noted that these Examples are intended to illustrate but not limit the scope of the present invention.

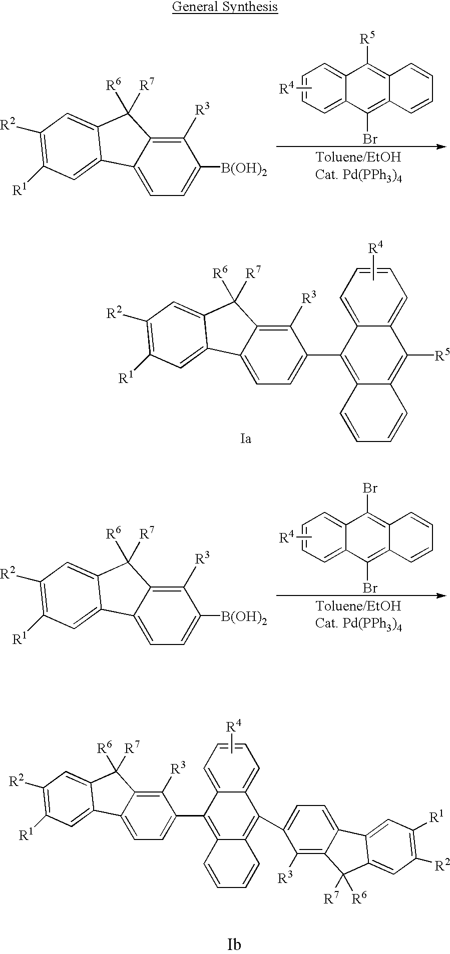

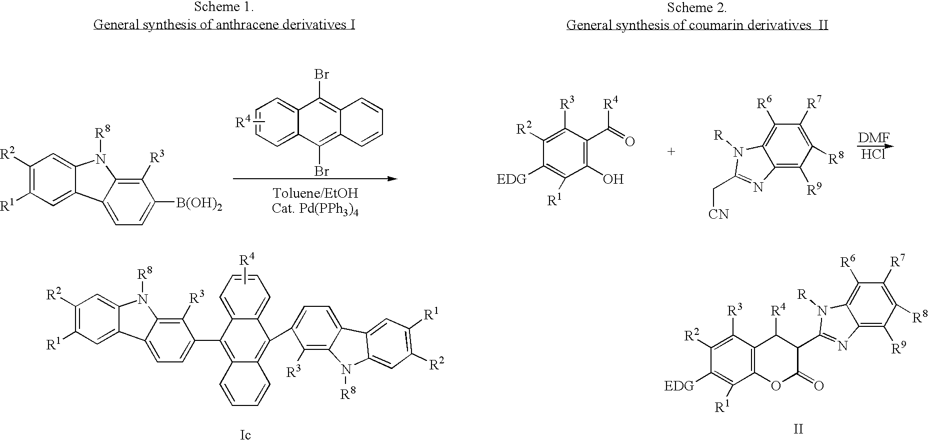

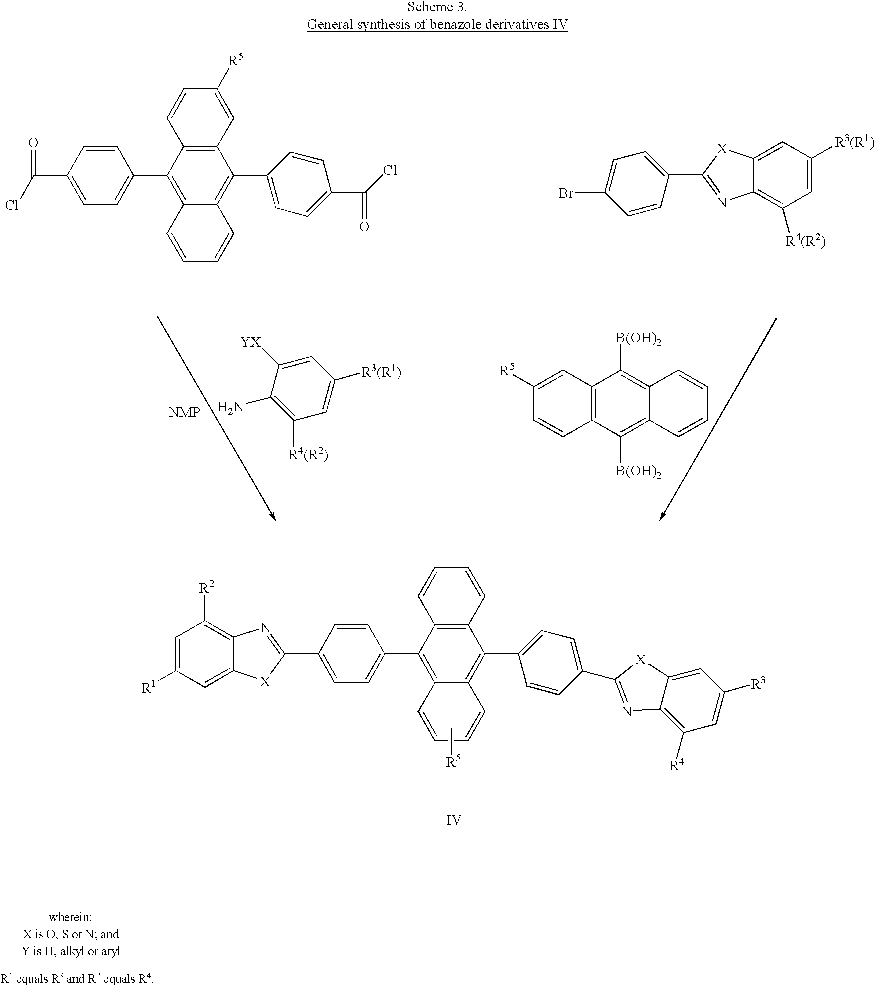

### Example 1

### Synthesis of 9,9-Diethylfluorene

To a mechanically stirred mixture of fluorine (83.2 g. 0.5 mol.), powdered potassium hydroxide (140 g., 2.5 mol.), potassium iodide (4.0 g., 0.024 mol.) and DMSO (225 ml), cooled to 15-20° C., bromoethane (104 ml., 151.84 g., 1.39 mol.) was added over a period of 1.5 hours, and allowed to stir at room temperature overnight. The mixture was diluted with water (1200 ml), and extracted with toluene (2×400 ml). The toluene extract was washed with water, dried and concentrated to get 116.66 g., of a red oil. This was distilled at 1.2 mm, b.p. 125° C. to get a colorless oil, that solidified, 104.32 g., (94% yield).

### Example 2

### Synthesis of 2-Bromo-9,9-diethylfluorene

To a solution of diethylfluorene (22.2 g., 0.1 mol.) in propylene carbonate (100 ml), N-bromosuccinimide (17.8 g., 0.1 mol.) was added at 57° C. in portions and the mixture was stirred for 30 minutes at 60° C. The mixture was diluted with 1200 ml of water and extracted with 500 ml of toluene. The toluene extract was washed 3 times with 300 ml portions of water, dried and concentrated. The crude product from 3 batches of the same size totaled 117 g. oil. This was distilled at 2 mm. The first fraction, b.p. 90-93° C., 22.33 g., was found to be propylene carbonate. The second fraction, b. p. 155-165° C., 81.0 g. (89.7% yield), was the desired compound.

### Example 3

### Synthesis of 9,9-diethylfluorenyl-2-boronic Acid

A solution of n-BuLi (1.6 M in hexane, 100 mL, 0.16 mol) was added via an addition funnel to 2-bromo-9,9-diethylfluorene prepared by example 2 (42.0 g, 0.14 mol) in 200 mL of dry THF at −78 C. The yellow suspension was stirred at this temperature for a half hour, a solution of B(OMe)₃ (26.6 mL, 29.1 g, 0.28 mol) in 150 mL of dry THF was added dropwise, with the temperature kept below −60° C. The resulting colorless solution was allowed to warm to room temperature 2 hour, then 300 mL of 5 M HCl was added and the mixture stirred for a further one hour under nitrogen. Water and ether were added, and the aqueous layer was extracted several times with ether. The combined organic extracts were dried over MgSO4 and evaporated under reduced pressure to yield a white solid (34.0 g, 95%), which was used in the coupling reaction without further purification.

### Example 4

### Synthesis of 9,10-di[2-(9,9-diethylfluorenyl)]anthracene (compound Ib-2)

Pd(PPh₃)₄ (1.0 g, 0.8 mmol) and 300 mL of 2.0 M aqueous Na₂CO₃ were added to a solution of 9,10-dibromoanthracene (34.0 g, 0.1 mol) 9,9-diethylfluorenyl-2-boronic acid (40.0 g, 0.232 mol) in 600 mL of toluene and 100 mL of ethanol. The reaction mixture was purged with nitrogen for 10 min. After refluxing overnight, the organic suspension layer was separated while hot and was added 300 mL of 2.0 N HCl and refluxed for one hour with vigorous stirring. The aqueous layer was separated again while hot followed by washing with water three times until pH is about 7. The precipitates from the organic layer was filtered and purified by chromatography. 47.5 g of pure 9,10-di[2-(9,9-diethylfluorenyl)]anthracene (compound Ib-2) was obtained. Yield 80.0%.

### Example 5

### Synthesis of 2-tert-butyl-9,10-di[2-(9,9-diethylfluorenyl)]anthracene (compound Ib-4)

Pd(PPh₃)₄ (0.50 g, 0.4 mmol) and 150 mL of 2.0 M aqueous Na₂CO₃ were added to a solution of 2-tert-butyl-9.10-dibromoanthracene (19.8 g, 0.05 mol) 9,9-diethylfluorenyl-2-boronic acid (20.0 g, 0.12 mol) in 300 mL of toluene and 50 mL of ethanol. The reaction mixture was purged with nitrogen for 10 min. After refluxing overnight, the organic suspension layer was separated while hot and was added 150 mL of 2.0 N HCl and refluxed for one hour with vigorous stirring. The aqueous layer was separated again while hot followed by washing with water three times until pH is about 7. The precipitates from the organic layer was filtered and purified by chromatography. 27.4 g of pure 2-tert-butyl-9,10-di[2-(9,9-diethylfluorenyl)]anthracene (compound Ib-4) was obtained. Yield 80.0%.

### Example 6

### Synthesis of 2,7,9,10-tetras[2-(9,9-diethylfluorenyl)]anthracene (compound III-22)

Pd(PPh₃)₄ (0.20 g) and 50 mL of 2.0 M aqueous Na₂CO₃ were added to a solution of 2,7,9,10-tetrabromoanthracene (4.94 g, 0.01 mol) and 9,9-diethylfluorenyl-2-boronic acid (13.2 g, 0.05 mol) in 100 mL of toluene and 20 mL of ethanol. The reaction mixture was purged with nitrogen for 10 min. After refluxing overnight, the organic suspension layer was separated while hot and was added 50 mL of 2.0 N HCl and refluxed for 24 hour with vigorous stirring. The aqueous layer was separated again while hot followed by washing with water three times until pH is about 7. The organic solvents were revolved via vacuum rotary evaporator then precipitates from the organic layer was filtered and purified by chromatography. 7.4 g of pure 2,7,9,10-tetras[2-(9,9-diethylfluorenyl)]anthracene (compound III-22) was obtained. Yield 74.0%.

### Example 7

### Synthesis of 9-phenyl-10-[2-(9,9-diethylfluorenyl)]anthracene (compound Ia-2)

Pd(PPh₃)₄ (0.20 g) and 30 mL of 2.0 M aqueous Na₂CO₃ were added to a solution of 9-phenyl-10-bromoanthracene (6.62 g, 0.02 mol) and 9,9-diethylfluorenyl-2-boronic acid (5.4 g, 0.02 mol) in 50 mL of toluene and 10 mL of ethanol. The reaction mixture was purged with nitrogen for 10 min. After refluxing overnight, the organic suspension layer was separated while hot and was added 50 mL of 2.0 N HCl and refluxed for two hour with vigorous stirring. The aqueous layer was separated again while hot followed by washing with water three times until pH is about 7. The organic solvents were removed via vacuum rotary evaporator then precipitates from the organic layer was filtered and purified by chromatography. 8.7 g of pure 9-phenyl-10-[2-(9,9-diethylfluorenyl)]anthracene (compound Ia-2) was obtained. Yield 91.0%.

### Example 8

### Synthesis of 2-cyanophenylbenzimidazole

In a 250 mL of round flask are combined ethyl cyanoacetate (14.2 g, 0.12 mol), N-phenyl-1,2-phenylenediamine (15.5 g, 0.084 mol) and 15 mL of bis(2methoxyethyl)ether. The reaction mixture is heated, with stirring to 150˜160 C for three hours while water and ethanol by-products is distilled over. After cooling the reaction mixture was added 10 mL of isopropyl alcohol. The crude product is precipitated out and filtered. The 12.5 g of pure 2-cyanophenylbenzimidazole was obtained. Yield 65.0.0%.

### Example 9

### Synthesis of N-phenylimidazole-2,3,6,7-tetrahydro-N,N-diethyl-11H,5H, 11H-(1)benzopyropyrano(6,7,8-i j)quinolizin-11-one (Compound IIb-14)

To a 250 mL of round flask are combined 4-diethylamino-2-hydroxybenzaldehyde (6.2 g, 3.2 mmol), 2-cyanophenylbenzimidazole (7.4 g, 3.2 mmol) and 30 mL of N,N-dimethylformamide. The reaction mixture is heated, with stirring to 50 C, then 3 ml of HCl was added to reaction mixture. Heating is continue for an half hour at 90° C. another 6 mL of HCl was added and red-orange mixture is heated at 90° C. for an additional 30 min. After cooling the reaction mixture was added, with cooling and stirring, to 120 mL of distilled water. The resulting precipitates are filtered and washed with distilled water. A saturated sodium carbonate is added dropwise to the suspension which prepared from above obtained precipitates in 100 mL of distilled water with stirring until the pH is about 7˜8. Then the precipitates are filtered, washed with distilled water, cool alcohol. 9.1 g of pure of N-phenylimidazole-2,3,6,7-tetrahydro-N,N-diethyl-11H,5H, 11H-(1)benzopyropyrano(6,7,8-i j)quinolizin-11-one (Compound IIb-14) was obtained. Yield 70.0%.

Fabrication of Organic EL Devices:

Examples 10 to 36 were prepared in the following manner:

1. Indium tin oxide, 500 Angstroms in thickness, (ITO) coated glass, about 1 millimeter in thickness, was cleaned with a commercial detergent, rinsed with deionized water and dried in a vacuum oven at 60° C. for 1 hour. Immediately before use, the glass was treated with UV ozone for 0.5 hour.

2. The above prepared ITO substrate was placed in a vacuum deposition chamber. The deposition rate and layer thickness were controlled by an Inficon Model IC/5 controller. Under a pressure of slightly less than about 5×10⁻⁶ Torr, cupper phycynin CuPc was evaporated from an electrically heated tantalum boat to deposit an 20 nanometer (200 Angstroms) hole injecting layer on the ITO glass layer. The deposition rate of the CuPc was controlled at 0.4 nanometer/second.

3. Onto the hole transport layer, an aromatic amine NPB or a mixture of isomeric aromatic amines NPBX was evaporated from an electrically heated tantalum boat to deposit an 80 nanometer (800 Angstroms) hole transport layer on the ITO glass layer. The deposition rate of the amine compound was controlled at 0.6 nanometer/second.

4. Onto the hole transport layer, novel anthracene derivatives, Formula I, was deposited at an evaporation rate of 0.6 nanometer/second to form an 30 nanometer light emitting layer. This light emitting layer can also formed by co-deposition with luminescent materials, Formula II, or another dopand such as perylene, tetraphenyl pyrene, coumarin-6, coumarine-C545T, DMQA or DCJTB. The dopant concentration was controlled in the range from 0.1 to 5 mole percent in the host.

5. Onto the light emitting layer, novel benazole derivatives IV or commonly used metal chelate, aluminum 8-hydroxylquinolate (Alq) was deposited at an evaporation rate of 0.6 nanometer/second to form an 30 nanometer electron injecting and electron transporting layer.

6. A 100 nanometer magnesium silver alloy was deposited at a total deposition rate of 0.5 nanometer/second onto the electron injecting and electron transporting layer by simultaneous evaporation from two independently controlled tantalum boats containing Mg and Ag, respectively. The typical composition was 9:1 in atomic ratio of Mg to Ag. Finally, a 200 nanometer silver layer was overcoated on the Mg:Ag cathode for the primary purpose of protecting the reactive Mg from ambient moisture.

The devices as prepared above were retained in a dry box that was continuously purged with nitrogen gas. The performance of the devices was assessed by measuring its current-voltage characteristics and light output under a direct current measurement. The current-voltage characteristics were determined with a Keithley Model 238 High Current Source Measure Unit. The ITO electrode was always connected to the positive terminal of the current source. At the same time, the light output from the device was monitored by a silicon photodiode.

The performance characteristics of the devices in a general structure of ITO/CuPc (20 nm)/NPB (80 nm)/EML (30 nm)/ETL (30 nm)/9:1 Mg-Ag (100 nm) were evaluated under a constant current density of 40 mA/cm². The initial light intensity and color chromaticity of these devices are summarized in the following tables: Table 1, Table 2, Table 3 and table 4.

TABLE 1
ITO/CuPc (20 nm)/
NPB (80 nm)/EML (30 nm)/Alq (30 nm)/9:1 Mg—Ag (100 nm)

| | Emitting Layer (EML) | | | | Max EL |
|---|---|---|---|---|---|
| Examples | Host | Dopand(%) | cd/A | Voltage (V) | peak (nm) |
| 10 | Ib-2 | 0 | 1.9 | 11.5 | 452 |
| 11 | Ib-2 | Perylene (0.1%) | 3.2 | 12.3 | 460 |
| 12 | Ib-2 | Perylene (0.5%) | 2.9 | 12.3 | 460 |
| 13 | Ib-2 | Perylene (0.8%) | 3 | 12.1 | 460 |

These results demonstrate that a sustained high level of blue light output can be achieved in the organic EL devices comprising an anthracene host Ib-2 and a perylene blue dopand.

TABLE 2
ITO/CuPc (20 nm)/
NPB (80 nm)/EML (30 nm)/IV-25 (30 nm)/9:1 Mg—Ag (100 nm)

| | Emitting Layer | | | | Max EL |
|---|---|---|---|---|---|
| Examples | Host | Dopand(%) | cd/A | Voltage (V) | peak (nm) |
| 14 | Ib-2 | 0 | 1.7 | 12.4 | 452 |
| 15 | Ib-2 | Perylene (0.1%) | 4.65 | 12.2 | 460 |
| 16 | Ib-2 | Perylene (0.5%) | 4.2 | 11.9 | 460 |
| 17 | Ib-2 | Perylene (0.8%) | 3.8 | 11.5 | 460 |
| 18 | Ib-2 | Perylene (1.0%) | 3.1 | 12 | 460 |
| 19 | Ib-2 | Perylene (2.0%) | 2.7 | 11.8 | 460 |

These results demonstrate that more efficient blue light output can be achieved in the organic EL devices comprising an anthracene host Ib-2 and a perylene blue dopand by using an anthracene derivative IV-25 instead of Alq (see example 15).

TABLE 3
ITO/CuPc (20 nm)/
NPB (80 nm)/EML (30 nm)/Alq (30 nm)/9:1 Mg—Ag (100 nm)

| | Emitting Layer | | | | Max EL |
|---|---|---|---|---|---|
| Examples | Host | Dopand(%) | cd/A | Voltage (V) | peak (nm) |
| 22 | Alq | 0 | 2.5 | 10.0 | 524 |
| 23 | Alq | IId-16 (0.5%) | 2.5 | 10.1 | 524 |
| 24 | Alq | IId-16 (1.0%) | 2.8 | 9.8 | 516 |
| 25 | Alq | IId-16 (1.5%) | 2.9 | 9.6 | 508 |
| 26 | Ib-2 | 0 | 1.7 | 12.4 | 452 |
| 27 | Ib-2 | IId-16 (0.5%) | 3.2 | 10.5 | 476 |
| 28 | Ib-2 | IId-16 (1.0%) | 3.8 | 10.1 | 476 |
| 29 | Ib-2 | IId-16 (1.5%) | 4.4 | 10.2 | 476 |
| 30 | Ib-2 | Coumarine-545T | 5.5 | 10.1 | 500 |
| | | (III-26) (0.5%) | | | |
| 31 | Ib-2 | Coumarine-545T | 5.6 | 10.1 | 500 |
| | | (III-26) (1.0%) | | | |
| 32 | Ib-2 | Coumarine-545T | 5.5 | 9.3 | 500 |
| | | (III-26) (1.5%) | | | |

These results demonstrate that a sustained high level of blue-green light output can be achieved in the organic EL devices comprising an anthracene host Ib-2 and coumarins IId-16 and III-26. However, energy transfer is not efficient by using Alq as host and coumarin IId-16 as dopand.

TABLE 4
ITO/CuPc (20 nm)/
NPB (80 nm)/EML (30 nm)/Alq (30 nm)/9:1 Mg—Ag (100 nm)

| | Emitting Layer | | | | Max EL |
|---|---|---|---|---|---|
| Examples | Host | Dopand(%) | cd/A | Voltage (V) | peak (nm) |
| 33 | Ib-2 | 0 | 1.8 | 12.0 | 452 |
| 34 | Ib-2 | DCJTB (III-28) | | | |
| | | (0.1%) | 4.7 | 11.3 | 576 |
| 35 | Ib-2 | DCJTB (III-28) | | | |
| | | (0.5%) | 3.0 | 12.3 | 592 |
| 36 | Ib-2 | DCJTB (III-28) | | | |
| | | (1.0%) | 2.7 | 12.5 | 604 |

These results demonstrate that a sustained high level of red light output can be achieved in organic EL devices comprising an anthracene host (Ib-2) and an DCJTB red dopand (III-28).

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. An organic electroluminescent device comprising an anode, an organic medium including a hole injecting and transport layer, a light-emitting layer, an electron injecting and transport layer and a cathode, wherein:
the light-emitting layer of the organic EL medium comprises one or more anthracene derivatives or a mixture of one or more anthracene derivatives as host and other dopants of the following general structural formula: 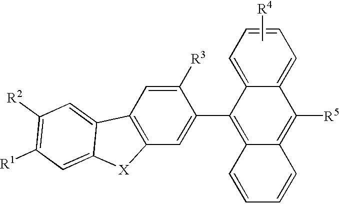
wherein:
R¹, R², R³ and R⁴ are individually hydrogen, alkyl, or alkoxyl groups containing 1 to 16 carbon atoms, alkenyl groups containing at least one carbon-carbon double bond, aryl or substituted aryl group containing 6 to 24 carbon atoms, heteroaryl or substituted heteroaryl group containing 5 to 24 carbon atoms, amino group, N-alkylamino group, N-arylamino group, N,N-dialkylamino group, N,N-diaryl group, cyano group, perfluoroalkyl group containing 1-8 carbon atoms, chlorine, bromine, and fluorine;
R⁵ is alkyl group or perfluoroalkyl group containing 1 to 16 carbon atoms; aryl or substituted aryl group containing 6 to 24 carbon atoms; heteroaryl or substituted heteroaryl group containing 5 to 24 carbon atoms, and cyano group, chlorine, bromine, and fluorine, and
X is methylene group, dialkyl methylene and diaryl methylene groups, hetero atom such as oxygen, sulfur, or alkyl or aryl substituted amino groups, or dialkyl or diaryl substituted silyl groups; and as a dopant one or more substances selected from the group consisting of:
one or more luminescent coumarin derivatives of the following general formula: 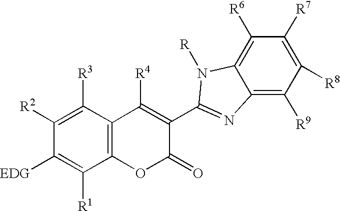
wherein:
R is hydrogen, alkyl of from 1-24 carbon atoms, aryl, hereoaryl or carbocyclic systems;
R¹, R², R³, R⁴, R⁵, R⁶, R⁷, R⁸ and R⁹ are individually alkyl of from 1 to 20 carbon atoms, aryl or carbocyclic systems;
EDG is hydrogen, alkyl group of from 1-24 carbon atoms, aryl group of from 5-24 carbon atoms, or electron donating groups;
—OR¹⁰ 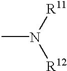
wherein:
R¹⁰, R¹¹ and R¹² are individually alkyl of from 1 to 20 carbon atoms, aryl or carbocyclic systems; R¹¹ and R¹, R¹¹ and R¹², and R¹² and R² taken together can form ring systems, such as piperidine, julolidine, or tetramethyljulolidine;
one or more luminescent anthracene derivatives of the following general formula: 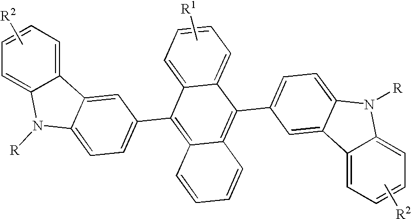
wherein:
R¹ is alkyl of from 1 to 20 carbon atoms; R and R² are individually hydrogen, alkyl of from 1 to 24 carbon atoms, aryl, hereoaryl group of from 5 to 24 carbon atoms; and wherein the electron injecting and transport layer of an EL medium comprises one or more benazole derivatives of the following general formula: 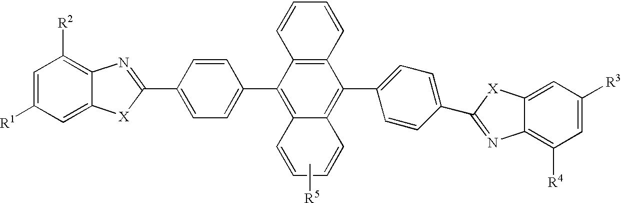
wherein:
R¹, R², R³, R⁴ and R⁵ are individual hydrogen, alkyl, or alkoxyl groups containing 1 to 16 carbon atoms, aryl or substituted aryl group containing 6 to 24 carbon atoms, heteroaryl or substituted heteroaryl group containing 5 to 24 carbon atoms; and
X is a methylene group, a dialkyl methylene and diaryl methylene groups, S, O or NR, where R is hydrogen, alkyl, or alkoxyl groups containing 1 to 16 carbon atoms, aryl or substituted aryl group containing 6 to 24 carbon atoms.

2. An organic electroluminescent device comprising an anode, an organic medium including a hole injecting and transport layer, a light-emitting layer, an electron injecting and transport layer and a cathode, wherein:
the light-emitting layer of the organic EL medium comprises as host one or more anthracene derivatives or a mixture of one or more anthracene derivatives as host and other dopants of the following general formula: 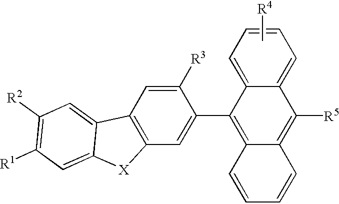
wherein:
R¹, R², R³ and R⁴ are individually hydrogen, alkyl, or alkoxyl groups containing 1 to 16 carbon atoms, alkenyl groups containing at least one carbon-carbon double bond, aryl or substituted aryl group containing 6 to 24 carbon atoms, heteroaryl or substituted heteroaryl group containing 5 to 24 carbon atoms, amino group, N-alkylamino group, N-arylamino group, N,N-dialkylamino group, N,N-diaryl group, cyano group, perfluoroalkyl group containing 11-8 carbon atoms, chlorine, bromine, and fluorine;
R⁵ is alkyl group or perfluoroalkyl group containing 1 to 16 carbon atoms; aryl or substituted aryl group containing 6 to 24 carbon atoms; heteroaryl or substituted heteroaryl group containing 5 to 24 carbon atoms, and cyano group, chlorine, bromine, and fluorine, and
X is methylene group, dialkyl methylene and diaryl methylene groups, hetero atom such as oxygen, sulfur, or alkyl or aryl substituted amino groups, or dialkyl or diaryl substituted silyl groups;

3. An organic electroluminescent device comprising an anode, an organic medium including a hole injecting and transport layer, a light-emitting layer, and an electron injecting and transport layer, and a cathode;
wherein:
the light-emitting layer of the organic EL medium comprises a host and as a dopant one or more luminescent coumarin derivatives of the following general formula: 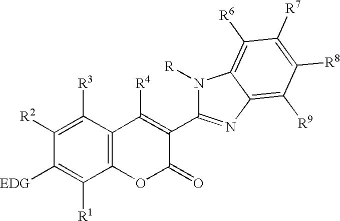
wherein:
R is hydrogen, alkyl of from 1-24 carbon atoms, aryl, hereoaryl or carbocyclic systems;
R¹, R², R³, R⁴, R⁵, R⁶, R⁷, R⁸ and R⁹ are individually alkyl of from 1 to 20 carbon atoms, aryl or carbocyclic systems;
EDG is hydrogen, alkyl group of from 1-24 carbon atoms, aryl group of from 5-24 carbon atoms, or electron donating groups;
—OR¹⁰ 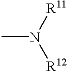
wherein:
R¹⁰, R¹¹ and R¹² are individually alkyl of from 1 to 20 carbon atoms, aryl or carbocyclic systems; R¹¹ and R¹, R¹¹ and R¹², and R¹² and R² taken together can form ring systems, such as piperidine, julolidine, or tetramethyljulolidine.

4. An organic electroluminescent device comprising an anode, an organic medium including a hole injecting and transport layer, a light-emitting layer, and an electron injecting and transport layer, and a cathode;
wherein:
the light-emitting layer of the organic EL medium comprises a host and as a dopant one or more of luminescent anthracene derivatives of the following general formula: 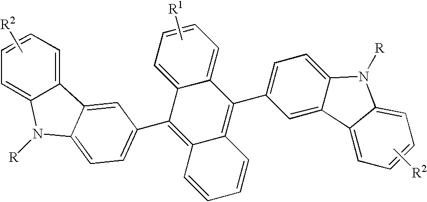
wherein:
R¹ is alkyl of from 1 to 20 carbon atoms; R and R² are individually hydrogen, alkyl of from 1 to 24 carbon atoms, aryl, hereoaryl group of from 5 to 24 carbon atoms.

5. An organic electroluminescent device comprising an anode, an organic medium including a hole injecting and transport layer, a light-emitting layer, and an electron injecting and transport layer, and a cathode;
wherein:
the electron injecting and transport layer of an EL medium comprises one or more benazole derivatives of the following general formula: 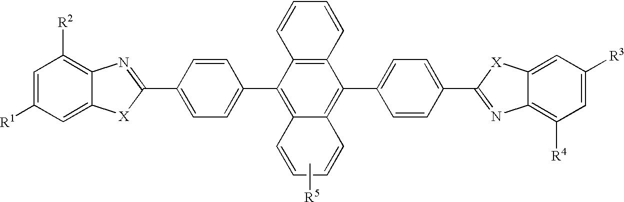
wherein:
R¹, R², R³, R⁴ and R⁵ are individual hydrogen, alkyl, or alkoxyl groups containing 1 to 16 carbon atoms, aryl or substituted aryl group containing 6 to 24 carbon atoms, heteroaryl or substituted heteroaryl group containing 5 to 24 carbon atoms; and
X is a methylene group, a dialkyl methylene and diaryl methylene groups, S, O or NR, where R is hydrogen, alkyl, or alkoxyl groups containing 1 to 16 carbon atoms, aryl or substituted aryl group containing 6 to 24 carbon atoms.

6. The organic electroluminescent device of claims 1 to 4 wherein said light emitting layer containing anthracene derivatives is formed by host materials doped with luminescent materials as dopants.

7. The organic electroluminescent device of claim 2 wherein said host materials comprises one or more of the following:

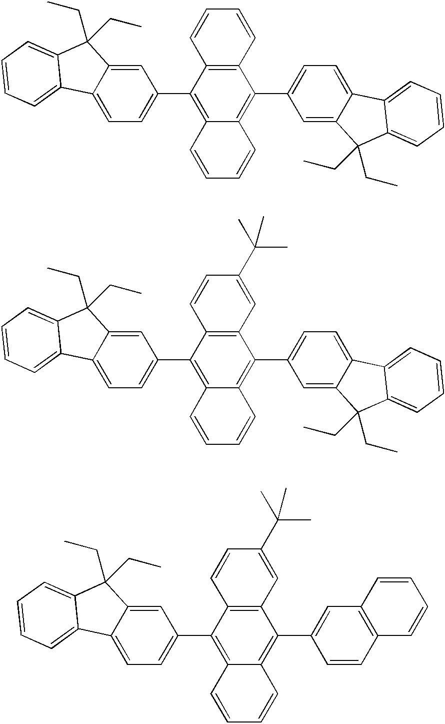

8. The organic electroluminescent device of claims 3 or 4 wherein said luminescent materials as dopants comprise one or more of the following:

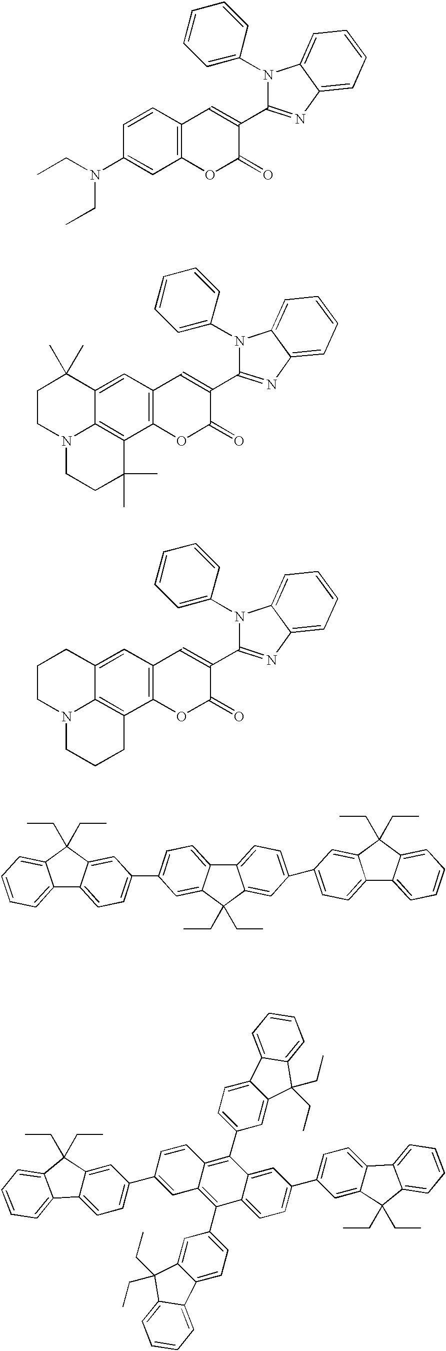

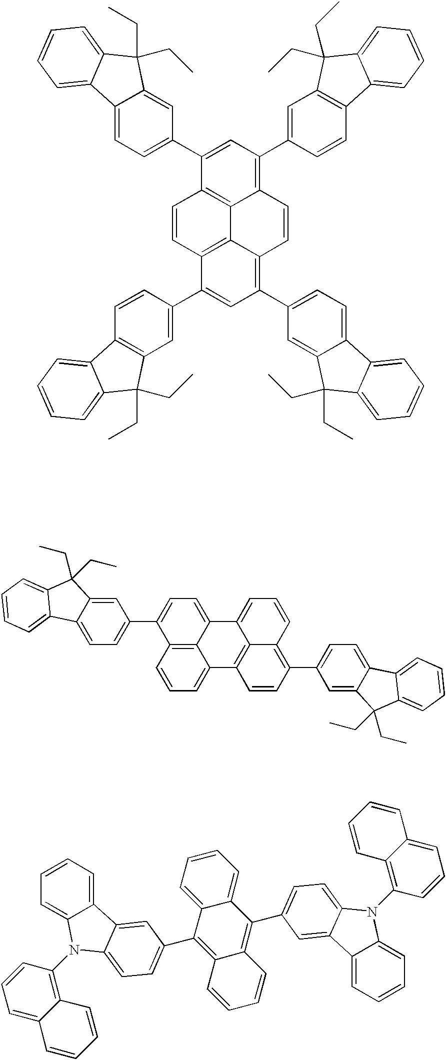

9. The organic electroluminescent device of claim 5 wherein said electron injecting and electron transporting material is comprised of [chemical structure]
